(19) United States
(12) Patent Application Publication
(10) Pub. No.: US 2014/0298224 A1
(43) Pub. Date: Oct. 2, 2014

(54) MAP DISPLAY DEVICE AND MAP DISPLAY METHOD

(71) Applicants: Hidekazu Arita, Tokyo (JP); Mitsuo Shimotani, Tokyo (JP)

(72) Inventors: Hidekazu Arita, Tokyo (JP); Mitsuo Shimotani, Tokyo (JP)

(73) Assignee: Mitsubishi Electric Corporation, Tokyo (JP)

(21) Appl. No.: 14/353,675

(22) PCT Filed: Jan. 12, 2012
(86) PCT No.: PCT/JP2012/050512

§ 371 Date: Apr. 23, 2014

(51) Int. Cl. G06F 3/0484

(52) U.S. Cl. CPC G06F 3/0484
USPC 715/765

(57) ABSTRACT

An object of the present invention is to provide a map display device and a map display method for simultaneously displaying a plurality of map drawing pictures so as to improve convenience for a user. The map display device includes an input unit that receives input of user operation related to display of a drawing picture, and a controller for controlling an overlapping state between first and second drawing pictures in accordance with input of user operation and outputting, to a display unit, a picture in which one of the first and second drawing objects masks the other one in a portion where the first and second drawing pictures are overlapped with each other. The controller changes display of one of the first and second drawing pictures in association with input of user operation to the other one.

### TECHNICAL FIELD

The present invention relates to a map display device and a map display method, and particularly relates to a map display device and a map display method for simultaneously displaying a plurality of information drawing pictures on a display screen.

### BACKGROUND ART

In an exemplary map display method of displaying a plurality of map drawing pictures on a display screen, the display screen is divided into two regions and a map drawing picture around a current position of a vehicle or the like is displayed in each of the regions (see Patent Document 1). The map drawing picture herein is a picture including a drawing object related to map display. The drawing object includes a road line, a character, topography, a building, an icon, a background color (including a transparent or a translucent color), associated information, or the like. The display screen is a display for actually displaying a map drawing picture. The map drawing picture is displayed in a predetermined display region in the display screen.

According to this map display method, one of the display regions includes a map drawing picture related to route guide and the other one of the display regions includes a map drawing picture related to similar route guide on a different scale. The map display method is thus useful for a user.

According to the map display method of Patent Document 1, the boundary between the right and left display regions is shiftable, and the displayed maps are displaced in accordance with shift of the boundary. This configuration fixes a content displayed at the center before and after the shift of the boundary, thereby enhancing convenience.

### PRIOR ART DOCUMENT

### Patent Document

Patent Document 1: Japanese Patent Application Laid-Open No. 2001-174271

### SUMMARY OF INVENTION

### Problems to be Solved by the Invention

In a map display method of displaying two pictures, displayed maps can be easily compared with each other by applying, to both of the pictures, identical map display setting such as a scale or a color tone of the maps. However, when a user utilizes while changing display setting of one of the maps, such display setting may cause display quite different from that of the other map. This causes a problem that the displayed maps in these pictures are hard to compare with each other. In this case, the user needs to perform operation of changing the display setting of the other map in a similar manner. This is a troublesome task for the user.

As to this point, Patent Document 1 merely refers to displacing a map in accordance with shift of a boundary between display regions. There is a problem of insufficient convenience in display of a plurality of pictures.

In view of the problems mentioned above, an object of the present invention is to provide a map display device and a map display method for simultaneously displaying a plurality of map drawing pictures so as to achieve fine usability for a user.

### Means for Solving the Problems

A map display device according to the present invention is capable of displaying a plurality of drawing pictures including a first drawing picture and a second drawing picture in an at least partially overlapping manner. The first drawing picture includes at least one first drawing object, the second drawing picture includes at least one second drawing object, at least one of the first and second drawing objects includes a drawing object related to map information, and the first and second drawing pictures are equal or different in size. The map display device according to the present invention includes: an input unit that receives input of user operation related to display of a drawing picture; and a controller for controlling an overlapping state between the first and second drawing pictures in accordance with input of user operation received by the input unit and outputting, to a display unit, a picture in which one of the first and second drawing objects masks the other one in a portion where the first and second drawing pictures are overlapped with each other; wherein the controller changes display of one of the first and second drawing pictures in association with input, received by the input unit, of user operation to the other one of the first and second drawing pictures.

A map display method according to the present invention is for displaying a plurality of drawing pictures including a first drawing picture and a second drawing picture in an at least partially overlapping manner. The first drawing picture displays at least one first drawing object, the second drawing picture displays at least one second drawing object, at least one of the first and second drawing pictures includes a drawing object related to map information, and the first and second drawing pictures are equal or different in size. The map display method according to the present invention includes the steps of: (a) receiving input of user operation related to display of a drawing picture, (b) displaying the plurality of drawing pictures, (c) prior to the step (b), controlling an overlapping state between the first and second drawing pictures in accordance with input of user operation received in the step (a), and masking one of the first and second drawing objects with the other one in a portion where the first and second drawing pictures are overlapped with each other, and (d) prior to the step (b), changing display of one of the first and second drawing pictures in association with input, received in the step (a), of user operation to the other one of the first and second drawing pictures.

### Effects of the Invention

A map display device according to the present invention includes an input unit that receives input of user operation related to display of a drawing picture, and a controller for controlling an overlapping state between first and second drawing pictures in accordance with input of user operation received by the input unit and outputting, to a display unit, a picture in which one of the first and second drawing objects masks the other one in a portion where the first and second drawing pictures are overlapped with each other. The controller changes display of one of the first and second drawing pictures in association with input, received by the input unit, of user operation to the other one of the first and second drawing pictures. This configuration achieves map display of fine usability for a user.

A map display method according to the present invention includes the steps of (a) receiving input of user operation related to display of a drawing picture, (b) displaying a plurality of drawing pictures, (c) prior to the step (b), controlling an overlapping state between first and second drawing pictures in accordance with input of user operation received in the step (a), and masking one of first and second drawing objects with the other one in a portion where the first and second drawing pictures are overlapped with each other, and (d) prior to the step (b), changing display of one of the first and second drawing pictures in association with input, received in the step (a), of user operation to the other one of the first and second drawing pictures. This configuration achieves map display of fine usability for a user.

The objects, features, aspects, and advantages of the present invention will be made more obvious with reference to the following detailed description and the accompanying drawings.

### BRIEF DESCRIPTION OF DRAWINGS

FIG. 1 is a view showing a conceptual entire configuration of a map display device.

FIG. 2 is a view showing a conceptual configuration of a controller in the map display device.

FIG. 3 is a flowchart illustrating behavior of the map display device.

FIG. 4 is a flowchart illustrating behavior of the map display device.

FIG. 5 is a view illustrating behavior of the map display device.

FIG. 6 is a view illustrating behavior of the map display device.

FIG. 7 shows views illustrating behavior of the map display device.

FIG. 8 is a flowchart illustrating behavior of the map display device.

FIG. 9 is a view illustrating behavior of the map display device.

FIG. 10 is a view illustrating behavior of the map display device.

FIG. 11 is a flowchart illustrating behavior of the map display device.

FIG. 12 is a view illustrating behavior of the map display device.

FIG. 13 is a view illustrating behavior of the map display device.

FIG. 14 is a flowchart illustrating behavior of the map display device.

FIG. 15 is a view illustrating behavior of the map display device.

FIG. 16 shows views illustrating behavior of the map display device.

FIG. 17 is a flowchart illustrating behavior of the map display device.

FIG. 18 is a view illustrating behavior of the map display device.

FIG. 19 shows views illustrating behavior of the map display device.

FIG. 20 is a view illustrating behavior according to a specific example 1 of the map display device.

FIG. 21 is a flowchart illustrating behavior according to the specific example 1 of the map display device.

FIG. 22 is a view illustrating behavior according to the specific example 1 of the map display device.

FIG. 23 is a view illustrating behavior according to a specific example 2 of the map display device.

FIG. 24 is a flowchart illustrating behavior according to the specific example 2 of the map display device.

FIG. 25 is a flowchart illustrating behavior according to a specific example 3 of the map display device.

### DESCRIPTION OF EMBODIMENT

### Embodiment 1

### Configuration

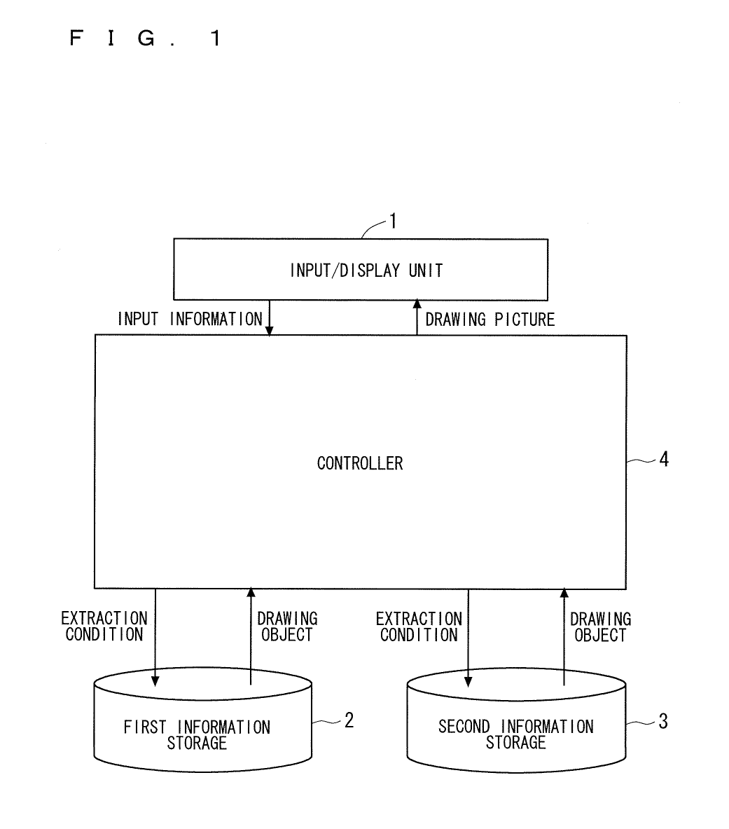

A conceptual entire configuration of a map display device according to an embodiment 1 is described with reference to FIG. 1. Although the map display device is not particularly limited in terms of its purpose of use, the map display device according to the following embodiment described below is assumed to be a car navigation system equipped on a vehicle as a mobile body.

As shown in FIG. 1, the map display device includes an input/display unit 1, a controller 4, a first information storage 2, and a second information storage 3. The input/display unit 1 functions as both an input unit that receives input of user operation related to display on a screen and a display that displays a plurality of drawing pictures on the screen. The controller 4 controls display behavior of a map drawing picture in accordance with input of user operation received by the input/display unit 1. The first information storage 2 and the second information storage 3 each store a drawing object and the like to be referred to upon behavior control by the controller 4.

The drawing object is displayed in a drawing picture and includes a road line, a character, topography, a building, an icon, a background color (possibly a transparent or translucent color), associated information, or the like. The background color included in the drawing object (a background drawing object) is not necessarily painted uniformly but can have gradation or can be painted partially in a drawing picture.

The input/display unit 1 is specifically embodied by a touch panel (a display device including a touch panel) or the like. The touch panel receives user's contact (touch) on a display screen and analyzes a touched position, a motion, and the like on the display screen to comprehend user's intention. Expected user's intention can be operation on a displayed map, a route search command, operation on built-in audio equipment, or the like. Examples of such map operation include changing a scale, changing a display position on a map (scrolling), searching for information on a current position and its periphery, and comparing the information.

The first information storage 2 and the second information storage 3 each store a drawing object related to map information or the like. More specifically, the first information storage 2 and the second information storage 3 each store map data on topography or the like, road data associated with a corresponding position on the map, building data (a figure and a shape), background color data, or the like. The building data includes a three-dimensional shape, a type, a name, and the like of the building itself. The information stored in each of the first information storage 2 and the second information storage 3 is not limited to such a drawing object related to map information, but each of the first information storage 2 and the second information storage 3 can store any other drawing object to be displayed at the input/display unit 1.

Each of the first information storage 2 and the second information storage 3 is specifically embodied by a hard disk drive, a memory card, a DVD, a Blu-ray Disc, or the like.

The controller 4 controls each functional unit included in the map display device and causes the input/display unit 1 to display a map drawing picture or the like. As shown in FIG. 1, the controller 4 analyzes user input information to form an extraction condition that relates to a drawing object and is necessary for formation of a map drawing picture. In a case where the controller 4 analyzes input information to comprehend user's intention of “search for peripheral expressway information”, the controller 4 forms a condition for extracting a drawing object of ordinary roads around the current position and a drawing object of expressways around the current position.

The controller 4 further extracts a corresponding drawing object from each of the first information storage 2 and the second information storage 3 under the extraction condition, and causes the input/display unit 1 to display each of the extracted drawing objects in a desired mode. The controller 4 is specifically embodied by a computer (CPU) and a program thereof.

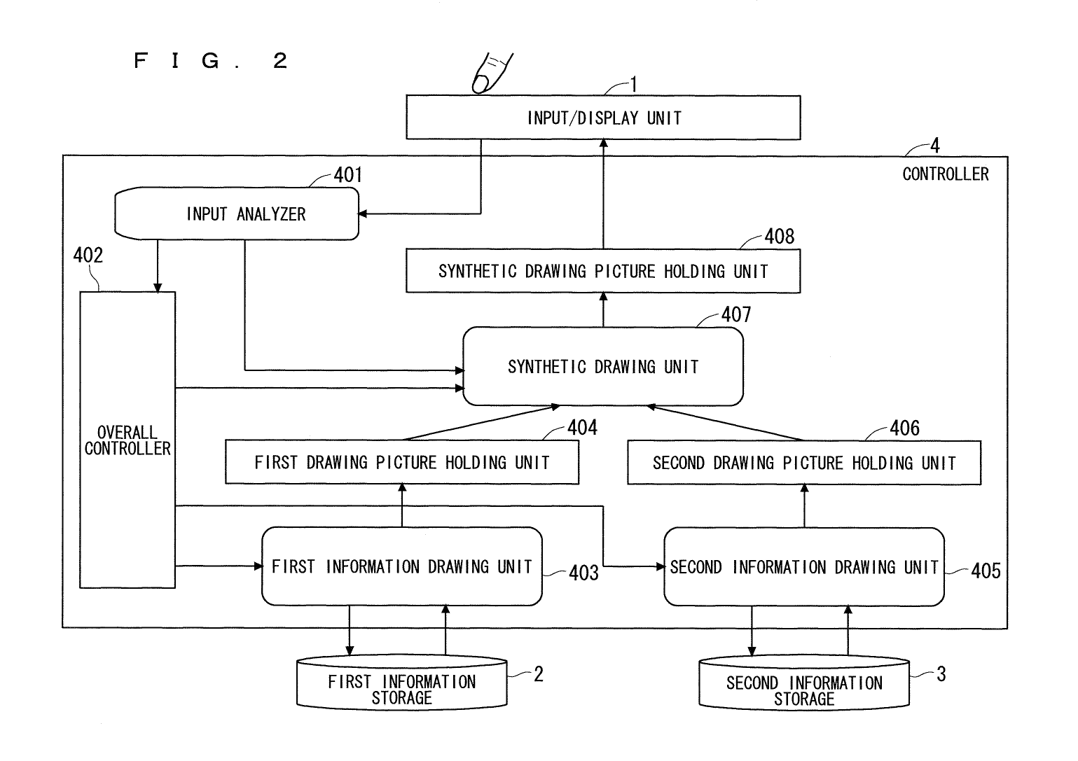

FIG. 2 particularly illustrates a detailed conceptual configuration of the controller 4 in the configuration of the map display device shown in FIG. 1.

The controller 4 includes an input analyzer 401, an overall controller 402, a first information drawing unit 403, a second information drawing unit 405, a first drawing picture holding unit 404, a second drawing picture holding unit 406, a synthetic drawing unit 407, and a synthetic drawing picture holding unit 408. The input analyzer 401 analyzes input information from the input/display unit 1. The overall controller 402 controls the first information drawing unit 403, the second information drawing unit 405, and the synthetic drawing unit 407 in accordance with a result of the analysis by the input analyzer 401, and causes the input/display unit 1 to display a map drawing picture or the like. The first information drawing unit 403 extracts a first drawing object as a drawing object stored in the first information storage 2 and draws, at the first drawing picture holding unit 404, a first drawing picture as a drawing picture including the first drawing object. The second information drawing unit 405 extracts a second drawing object as a drawing object stored in the second information storage 3 and draws, at the second drawing picture holding unit 406, a second drawing picture as a drawing picture including the second drawing object. The first drawing picture holding unit 404 holds the first drawing picture. The second drawing picture holding unit 406 holds the second drawing picture. The synthetic drawing unit 407 draws, at the synthetic drawing picture holding unit 408, a synthetic drawing picture from the first drawing picture and the second drawing picture. The synthetic drawing picture holding unit 408 holds the synthetic drawing picture formed by the synthetic drawing unit 407. The input/display unit 1 displays the synthetic drawing picture held in the synthetic drawing picture holding unit 408.

The input analyzer 401 analyzes input information according to user's intention. More specifically, the input analyzer 401 analyzes a content displayed in a drawing picture and conditions such as a position touched on the display screen by a user and a motion, and identifies operation (e.g. equipment operation) according to the user's intention. User operation on the touch panel includes conventional simple touch operation of simply touching an icon (ordinary touch operation), or dynamic “gesture operation” such as “drag operation” or “flick operation” to be described later.

The overall controller 402 specifies a necessary drawing object on the basis of the analysis result, causes the first information drawing unit 403 to extract the first drawing object from the first information storage 2, and causes the second information drawing unit 405 to extract the second drawing object from the second information storage 3.

The first information drawing unit 403 forms a first drawing picture from the extracted first drawing object, and draws the first drawing picture at the first drawing picture holding unit 404 (memory unit). The first drawing picture is drawn by combining map data, road data, building data, and the like in the extracted first drawing object.

The second information drawing unit 405 forms a second drawing picture from the extracted second drawing object, and draws the second drawing picture at the second drawing picture holding unit 406 (memory unit). The second drawing picture is drawn by combining map data, road data, building data, and the like in the extracted second drawing object.

Each of the first information drawing unit 403 and the second information drawing unit 405 is capable of adding, to the corresponding map drawing picture (the first drawing picture or the second drawing picture) thus formed, information generated in the device such as vehicle current position data or route data to a destination of the vehicle obtained by route search behavior, so as to draw at the corresponding drawing picture holding unit.

The overall controller 402 further causes the synthetic drawing unit 407 to synthesize the first drawing picture held in the first drawing picture holding unit 404 and the second drawing picture held in the second drawing picture holding unit 406 and draw at the synthetic drawing picture holding unit 408 (memory unit). A synthetic drawing picture is held in the synthetic drawing picture holding unit 408 and is then displayed at the input/display unit 1.

The synthetic drawing unit 407 forms the synthetic drawing picture by synthesizing the first drawing picture and the second drawing picture so as to be entirely or partially overlapped with each other while holding drawing contents of the first drawing picture and the second drawing picture. In a portion where the first drawing picture and the second drawing picture are overlapped with each other, a drawing object in an upper drawing picture of the overlapped portion masks a drawing object in a lower drawing picture so that only the upper drawing object is visible. The drawing object in the lower drawing picture can be made visible by controlling an overlapping state between the drawing pictures to cancel the overlap. The “upper/lower” herein corresponds to the upper/lower direction along the normal line of a display screen and a closer side corresponds to the “upper” side. In fact, pieces of drawing picture data are overlapped conceptually.

The first drawing picture and the second drawing picture to be synthesized can alternatively have a first attention point and a second attention point, respectively.

The first attention point and the second attention point are particularly paid attention in the drawing pictures by a user, and are subjectively defined as points to be compared when the user refers to both the first drawing picture and the second drawing picture. Such points can be targets of drawing pictures to be formed, such as a current position of a vehicle on a peripheral map of the vehicle or a position of a destination on a peripheral map of the destination.

The first drawing object and the second drawing object can have predetermined relevance therebetween. Such predetermined relevance can be established in a case where the first drawing picture displays a map in a predetermined geographical range and the second drawing picture displays a map in a geographical range identical with or in the vicinity of that of the first drawing picture. There is also relevance on a travel route in a case where the first drawing picture displays the periphery of its own car and the second drawing picture displays a route to a destination. There is further temporal relevance such as a current travel route and a past travel record of an identical vehicle.

The order of overlapping map drawing pictures can be decided in accordance with user intention, e.g. for each combination of drawing objects. It is possible to comprehend more easily if the order is expressed in the up-down relationship according to the actual spatial disposition. For example, a drawing picture including elevated roads is overlapped on a drawing picture displaying ordinary roads. A drawing picture displaying a ground map is overlapped on a drawing picture displaying an underground map. It is noted that the overlapping order can be changeable at any time.

Basic Behavior

Behavior of the map display device according to the embodiment 1 is briefly described next.

The map display device according to the present invention is capable of displaying a plurality of overlapped map drawing pictures. The overlapping state between the map drawing pictures is updated so as to reflect user operation. The user is thus capable of comparing a drawing object in an upper map drawing picture and a drawing object in a lower map drawing picture so as to easily comprehend relevance therebetween. The controller 4, particularly the overall controller 402, controls each functional unit during the behavior.

The following description adopts a sliding method as a specific method of performing predetermined operation of updating a display position in the upper overlapped map drawing picture. In the sliding method to be described below, a display position in a drawing picture is shifted successively.

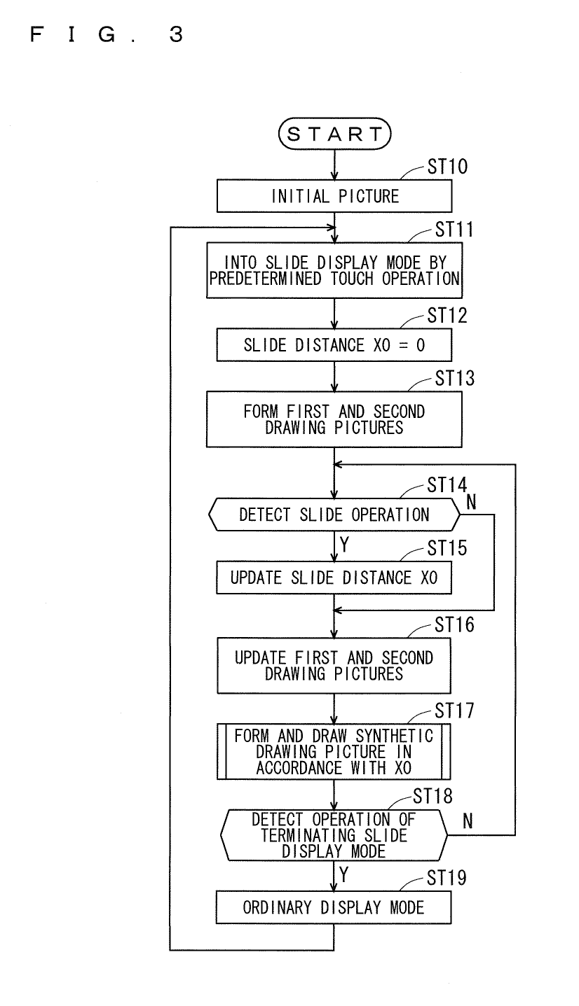

Specific behavior of the map display device is described with reference to FIG. 3.

Initially in step ST10, the map display device is turned on so as to cause the input/display unit 1 to display an initial picture. The initial picture is in an ordinary display mode of receiving ordinary touch operation.

Then in step ST11, a user performs predetermined operation on the initial picture displayed by the input/display unit 1 so as to transition into a slide display mode. In the slide display mode, a user is capable of sliding the upper map drawing picture by performing gesture operation to the input/display unit 1. The display mode is changed by touch operation, button operation, icon operation, gesture operation, voice input, or the like.

The overall controller 402 stores a parameter including a type of the display mode. Reference to the parameter enables determining whether or not the slide display mode is selected. For example, whether or not the slide display mode is selected is determined on the basis of the fact that the parameter has a value larger or smaller than a predetermined threshold. The parameter can be set by user operation such as icon operation or voice input, or can be changed automatically depending on preset conditions (including a state of a vehicle and a display state on the display screen). Still alternatively, an icon or the like can be displayed on the display screen of the input/display unit 1, so that a user is capable of visually recognizing whether or not the slide display mode is selected.

When the display mode transitions to the slide display mode, a slide distance X0 is set to zero in step ST12.

Then in step ST13, a first drawing picture and a second drawing picture are formed. The first information drawing unit 403 and the second information drawing unit 405 form the pictures in accordance with user input information as described above. The first and second drawing pictures thus formed are drawn and held in the first drawing picture holding unit 404 and the second drawing picture holding unit 406, respectively.

Subsequently in step ST14, it is detected whether or not slide operation of updating the display position in the upper overlapped map drawing picture is performed. The input analyzer 401 analyzes user's gesture operation at the input/display unit 1 to detect slide operation.

Then in step ST15, the slide distance X0 is updated in accordance with the slide operation.

Subsequently in step ST16, the drawing object displayed in each of the first drawing picture and the second drawing picture is updated. This update corresponds to information changing every moment, such as a displayed content varied in accordance with travel of the vehicle or traffic jam information.

Subsequently in step ST17, a display position of the upper overlapped map drawing picture is decided on the basis of the slide distance X0, and a synthetic drawing picture is formed from the first drawing picture and the second drawing picture. The synthetic drawing picture is drawn, in other words, displayed, at the input/display unit 1. Details thereof are to be described later.

Then in step ST18, the overall controller 402 determines whether or not the input analyzer 401 has detected predetermined operation of terminating the slide display mode. The process proceeds to step ST19 if the operation has been detected. In contrast, the process returns to step ST14 if the operation has not been detected. The slide display mode can be terminated by touch operation, button operation, icon operation, gesture operation, voice recognition, or the like.

The display mode then transitions to the ordinary display mode in step ST19, and the process returns to step ST11.

Board Slide

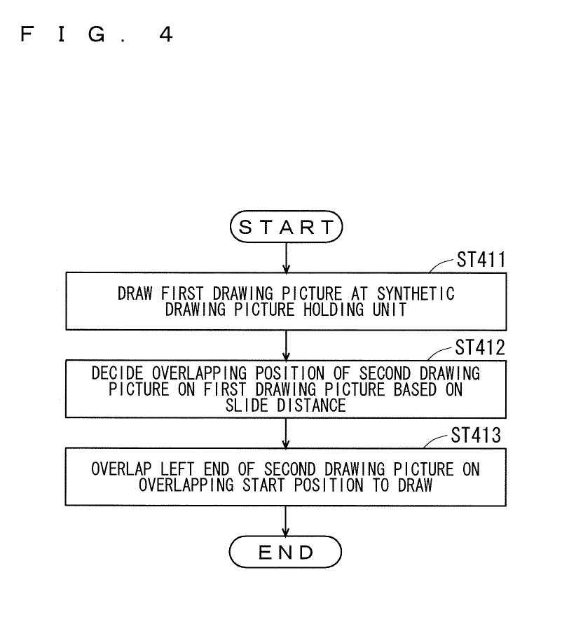

Details of step ST17 executed by the synthetic drawing unit 407 are described next with reference to FIGS. 4 to 7. A synthetic drawing picture is formed in this step. Described herein is formation in a case where the second drawing picture is slid out by means of board slide from a state where the second drawing picture is overlapped entirely on the first drawing picture (entirely overlapped state). Board slide is of a sliding type in which a drawing object shifts in a slide direction in association with sliding of a drawing picture. Sliding out is a motion of an upper drawing picture that shifts to the outside of the display screen from a state where drawing pictures are overlapped with each other. Complete sliding out is a slide out motion in a state where a drawing picture shifts so as to be located completely outside the display screen. Such complete sliding out is also called a completely displaced state, in view of the fact that any part of the drawing picture is not overlapped with the other drawing picture.

It is assumed that the second drawing picture is located above and the first drawing picture is located below throughout the present description. This positional relationship can be inverted.

Initially in step ST411 in FIG. 4, the first drawing picture held in the first drawing picture holding unit 404 is drawn at the synthetic drawing picture holding unit 408.

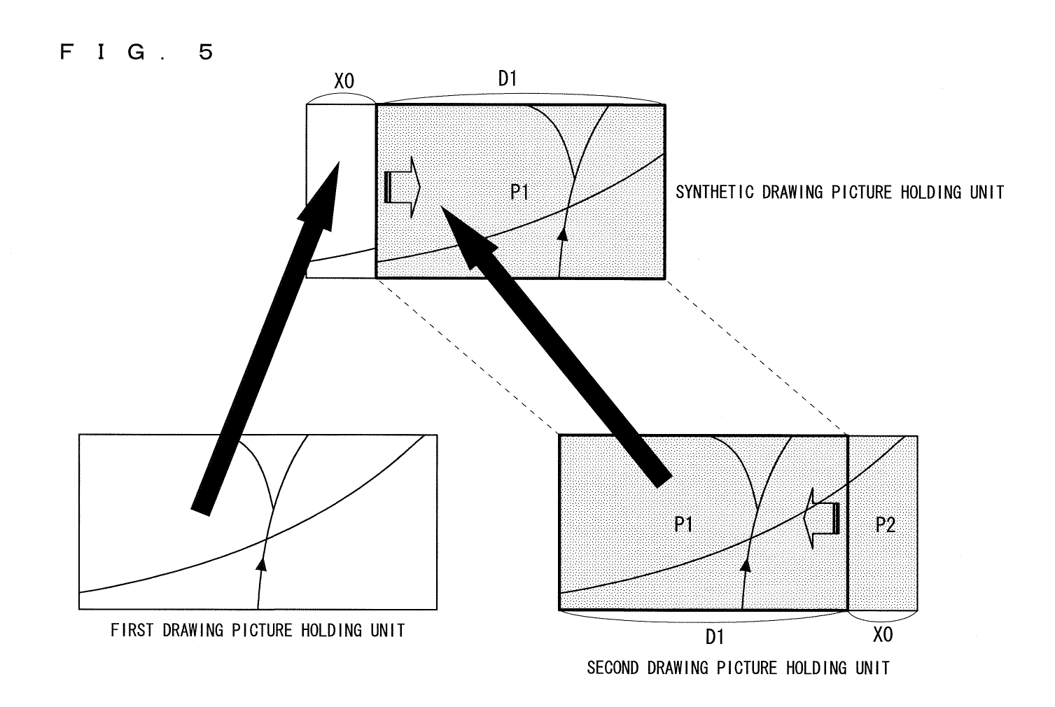

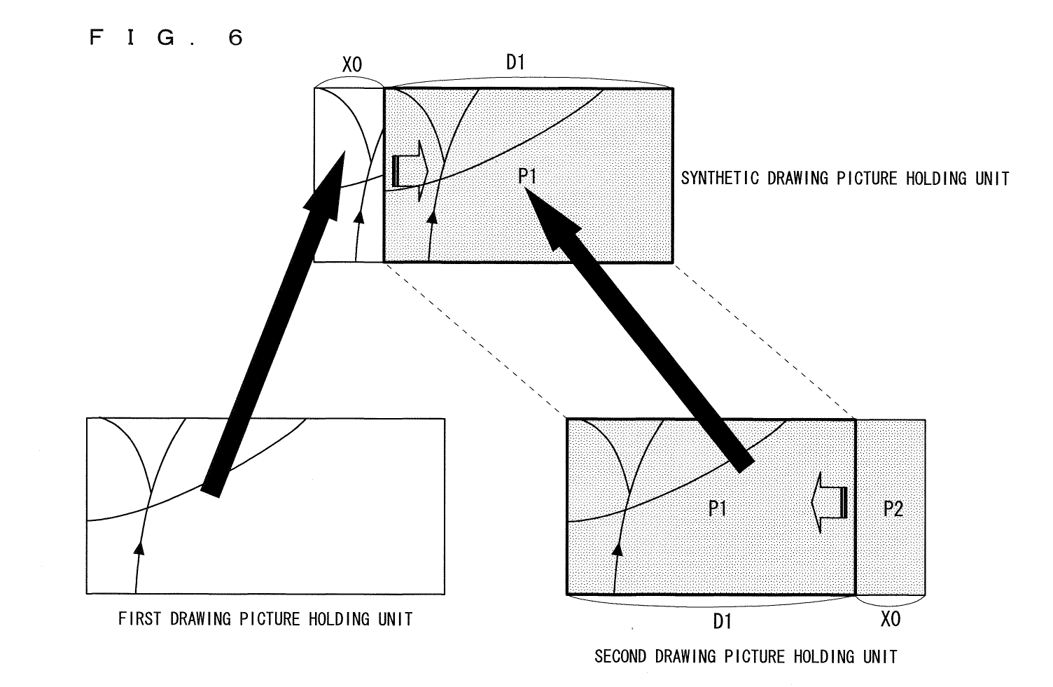

Subsequently in step ST412, an overlapping position of the second drawing picture on the first drawing picture is decided on the basis of the slide distance X0 updated in accordance with slide operation. FIGS. 5 and 6 schematically illustrate methods of synthesizing drawing pictures in cases where drawing objects are displayed at different positions in the drawing pictures.

If the slide distance X0 is zero, the first drawing picture and the second drawing picture are completely overlapped with each other and the second drawing object is positioned to completely mask the first drawing object. If attention points are set, the first drawing picture and the second drawing picture are preferably positioned so that a first attention point in the first drawing picture is overlapped and coincides with a second attention point in the second drawing picture on the display screen. In other words, when the first drawing picture and the second drawing picture each display a peripheral map of the vehicle, these drawing pictures are preferably located so that the current positions of the vehicle in these drawing pictures coincide with each other (the first attention point and the second attention point are located at a common position on the display screen in this case).

If the slide distance X0 is updated to a value other than zero, the overlapping position of the second drawing picture on the first drawing picture is decided on the basis of a position on the display screen touched in user's gesture operation or the like and the slide distance X0 corresponding to the motion.

Examples of user's gesture operation of updating the slide distance X0 include drag operation, shutter operation, and flick operation.

Drag operation is performed by user's gesture operation of shifting in a predetermined direction a finger touched on the display screen without releasing. In this case, the drawing picture is shifted along with this gesture operation. When a user performs such drag operation, the overlapping position of the second drawing picture on the first drawing picture is shifted in a finger shift direction by a shift distance (the slide distance X0 in FIGS. 5 and 6) of the finger. When the finger is dragged rightward, a position distant by the slide distance X0 from the left end of the first drawing picture to the right is decided as an overlapping start position. A mode of forming a synthetic drawing picture with drag operation is called a drag mode.

The second drawing picture slid by drag operation in the drag mode stays at the position after the slide until further gesture operation is performed. The second drawing picture can be alternatively returned to the overlapping position prior to drag operation when a user performs the drag operation and then releases a finger from the display screen. The slide operation in this case is called shutter operation so as to be distinguished from drag operation. A mode of forming a synthetic drawing picture with shutter operation is called a shutter mode.

In which one of the drag mode and the shutter mode slide operation is performed can be set by user's preliminary selection of an icon or the like, or can be distinguished by the input analyzer 401 that detects the number of fingers touching the display screen, variation in finger pressure, or the like.

Flick operation is performed by a motion like flicking a playing card with a finger touching the display screen (a motion like flipping). When a user performs such flick operation, the overlapping position of the second drawing picture on the first drawing picture is displaced in a direction of the flick operation by a distance corresponding to the flick operation. When the finger is dragged rightward, a position distant by the slide distance X0 from the left end of the first drawing picture to the right is decided as an overlapping start position. The slide distance X0 (see FIGS. 5 and 6) is an amount increasing along with time unlike in the drag mode. In this case, the second drawing picture is slid rightward and is completely slid out in the end. Such operation of shifting an upper overlapped drawing picture in a designated direction with predetermined touch operation and then shifting in accordance with predetermined inertia is called flick operation, and a mode of performing this operation is called a flick mode.

In the flick mode, flick operation is determined on the basis of any of the following conditions or by combination thereof, for example. (a) When a finger touches a touch panel and then quickly moves at predetermined or higher speed in a direction on the display screen, (b) when a finger presses the touch panel and then quickly moves with less press force at predetermined or higher speed in a direction on the display screen, or (c) when a finger touches the touch panel, then quickly moves at preliminarily predetermined or higher speed in a direction on the display screen, and is slightly released from the touch panel (in which case the touch panel is required to recognize a three-dimensional position).

The flick operation under the condition (a) is distinguished from drag operation on the basis of finger shift speed. The speed set as predetermined speed in each of the conditions (a) to (c) can be different from each other.

Then in step ST413, the second drawing picture is drawn in a state of being overlapped on the first drawing picture in accordance with the overlapping position, more particularly, the overlapping start position, decided in step ST412 (overwriting data). In a case where the second drawing picture is slid rightward out of the display screen, drawing is executed in the state where the second drawing picture is overlapped so that the left end thereof coincides with the overlapping start position.

A region in the second drawing picture not overlapped on the first drawing picture (P2 in FIGS. 5 and 6) is not displayed on the display screen. More specifically, the display screen displays the first drawing object in the first drawing picture having width equal to the slide distance X0 and not overlapped with the second drawing picture as well as the second drawing object in the second drawing picture having width D1 (except the width equal to the slide distance X0 from the right end) from the left end of the second drawing picture (P1 in FIGS. 5 and 6).

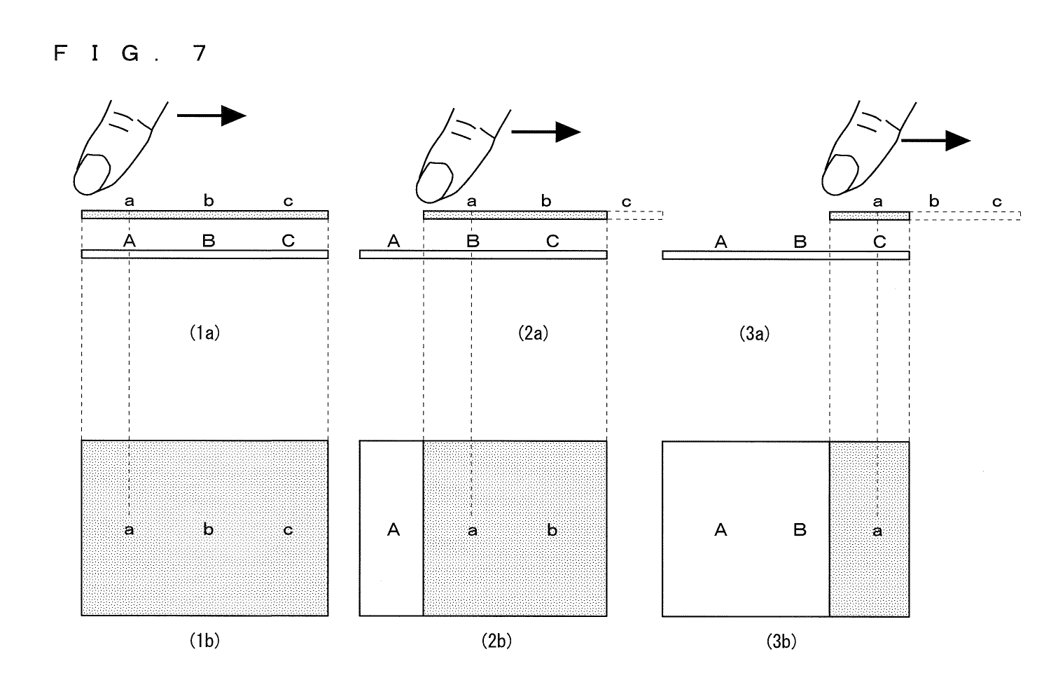

Sequentially forming a synthetic drawing picture as described above enables sliding out by means of board slide shown in FIG. 7. In FIG. 7, a second drawing picture including a drawing object a, a drawing object b, a drawing object c, and a second background drawing object is overlapped on a first drawing picture including a drawing object A, a drawing object B, a drawing object C, and a first background drawing object. It is assumed that the drawing object A is located at a first attention point in the first drawing picture and the drawing object a is located at a second attention point in the second drawing picture. The first background drawing object and the second background drawing object can be rectangular objects being equal in size to the drawing pictures and painted in cream. The drawing object a, the drawing object b, and the drawing object c are drawn on the second background drawing object in the second drawing picture.

In FIG. 7, portions (1a), (2a), and (3a) are pattern views of the lower first drawing picture and the upper second drawing picture seen in a lateral direction, whereas portions (1b), (2b), and (3b) are pattern views of the first drawing picture and the second drawing picture seen from above.

A user touches the input/display unit 1 with a finger and shifts the finger rightward in the figure without releasing (drag operation). In this case, the overlapping start position in the upper second drawing picture is updated sequentially (from 1a to 3a through 2a, or from 1b to 3b through 2b). The second drawing picture is displayed while shifting rightward like being entirely placed on a board and slid. In other words, the drawing objects a to c are shifted rightward like being placed on a board.

In the state of (1a) and (1b), the first drawing picture and the second drawing picture are completely overlapped with each other and the second background drawing object masks the drawing objects A to C. If the second drawing picture is smaller than the first drawing picture, the second drawing picture has only to be overlapped on a region in the first drawing picture equal in size to the second drawing picture.

In the state of (2a) and (2b), the drawing object a and the drawing object b are displayed on the display screen of the input/display unit 1, whereas the rightmost drawing object c is out of the display screen and is not displayed. The drawing object A is displayed whereas the drawing objects B and C are masked by the second background drawing object and are not displayed. In a case where attention points are set, the drawing object A serving as a first attention point and the drawing object a serving as a second attention point are displayed close to each other. It is thus possible to easily comprehend the relevance between these drawing objects (see also FIG. 6). Furthermore, relative positional relationship between the upper second drawing picture and the lower first drawing picture is changing continually in this case.

In the state of (3a) and (3b), the upper second drawing picture shifts further rightward, and the drawing object b is also out of the display screen of the input/display unit 1 and is not displayed. The drawing object A and the drawing object B are displayed whereas the drawing object C is masked by the second background drawing object and is not displayed. Furthermore, relative positional relationship between the upper second drawing picture and the lower first drawing picture is changing continually in this case.

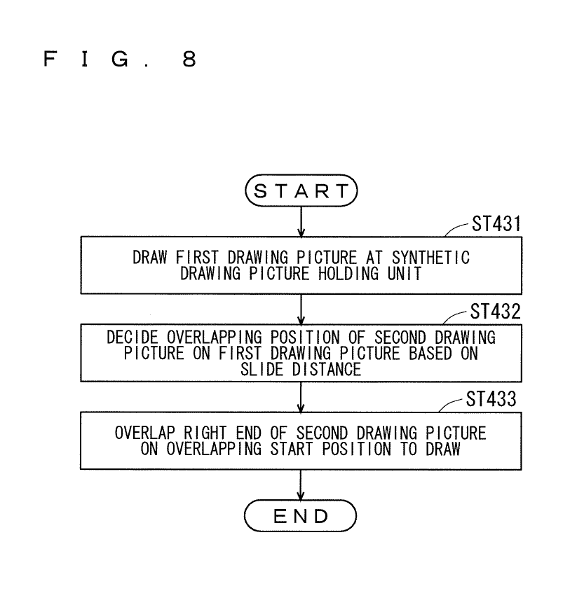

Formation of a synthetic drawing picture with sliding in by means of board slide is described next with reference to FIGS. 8 to 10. In this case, any parts of the map drawing pictures are not overlapped with each other at the initial stage (a completely displaced state). The second drawing picture shifts from the outside of the display screen, is gradually overlapped on the first drawing picture, and comes into a completely overlapped state in the end.

Initially in step ST431, the first drawing picture held in the first drawing picture holding unit 404 is drawn at the synthetic drawing picture holding unit 408.

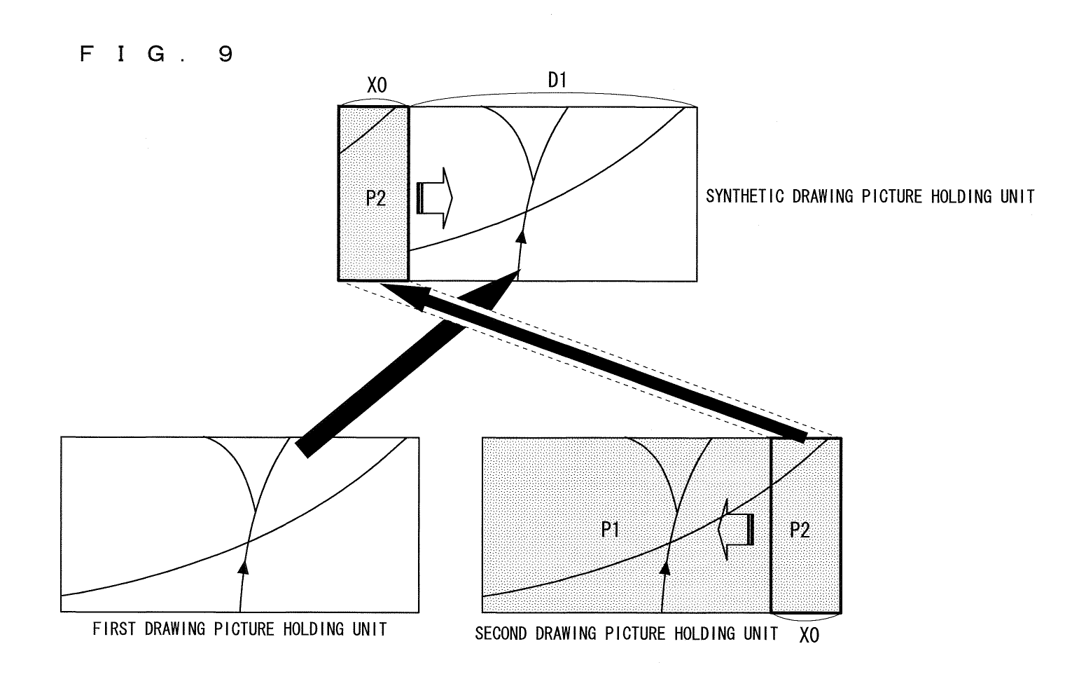

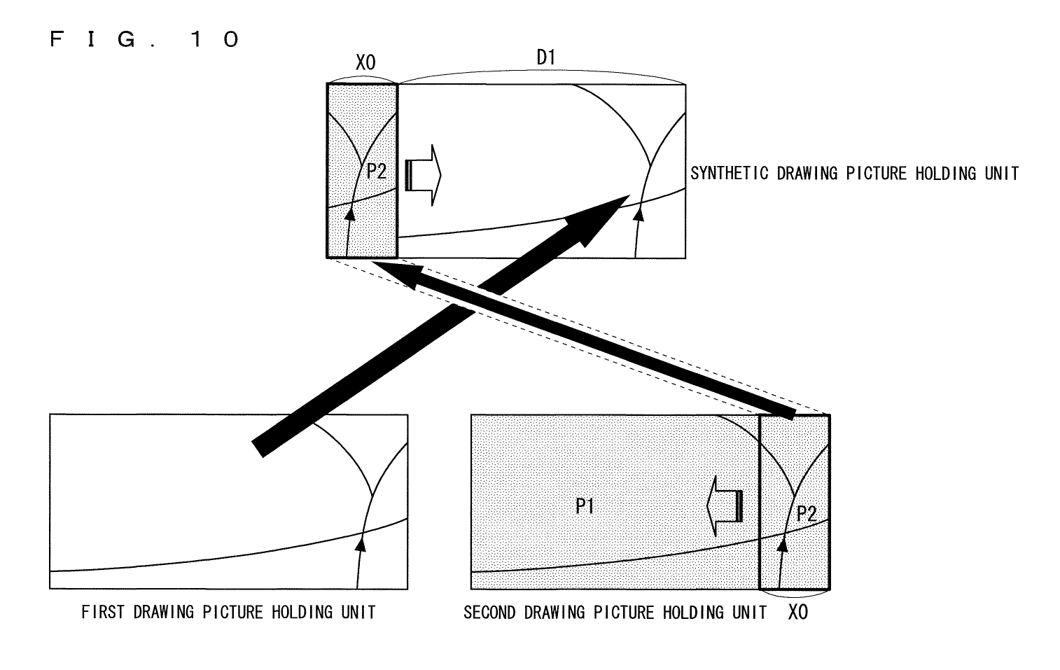

Subsequently in step ST432, an overlapping position of the second drawing picture on the first drawing picture is decided on the basis of the slide distance X0 updated in accordance with slide operation. FIGS. 9 and 10 schematically illustrate methods of synthesizing drawing pictures in cases where drawing objects are displayed at different positions in the drawing pictures.

If the slide distance X0 is zero, the overlapping position is decided so that the second drawing picture is completely out of the display screen.

If the slide distance X0 is updated to a value other than zero, the overlapping position is decided on the basis of the slide distance X0 corresponding to user's gesture operation.

If attention points are set, the overlapping position of the second drawing picture on the first drawing picture is preferably decided so that a first attention point in the first drawing picture gradually approaches a second attention point in the second drawing picture as the slide distance X0 is updated.

Then in step ST433, the second drawing picture is overlapped and drawn in accordance with the overlapping position, more particularly, the overlapping start position. In a case where the second drawing picture is slid from the left into the display screen, drawing is executed in the state where the second drawing picture is overlapped so that the right end thereof coincides with the overlapping start position.

A portion not overlapped with the first drawing picture (P1 in FIGS. 9 and 10) is not displayed on the display screen. In this state, the display screen displays the first drawing object in the first drawing picture having the width D1 and not overlapped with the second drawing picture as well as the second drawing object in the second drawing picture having width equal to the slide distance X0 from the right end of the second drawing picture (P2 in FIGS. 9 and 10).

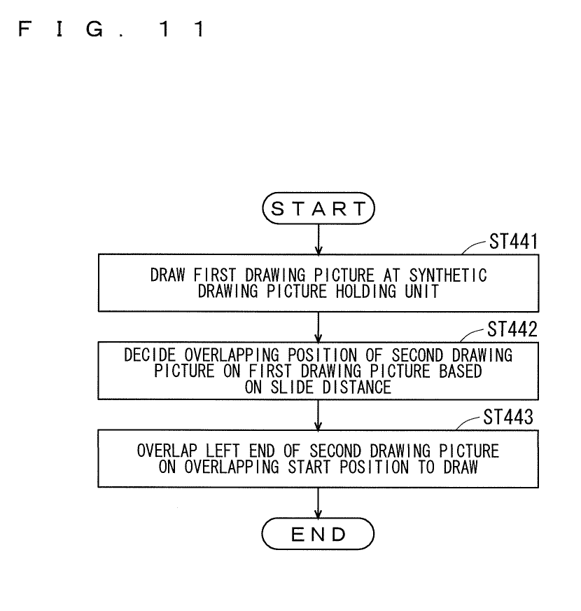

Sliding in rightward by means of board slide is described next with reference to FIGS. 11 to 13. In this case, the second drawing picture shifts rightward from the outside of the display screen so as to be overlapped with the first drawing picture.

Initially in step ST441, the first drawing picture held in the first drawing picture holding unit 404 is drawn at the synthetic drawing picture holding unit 408.

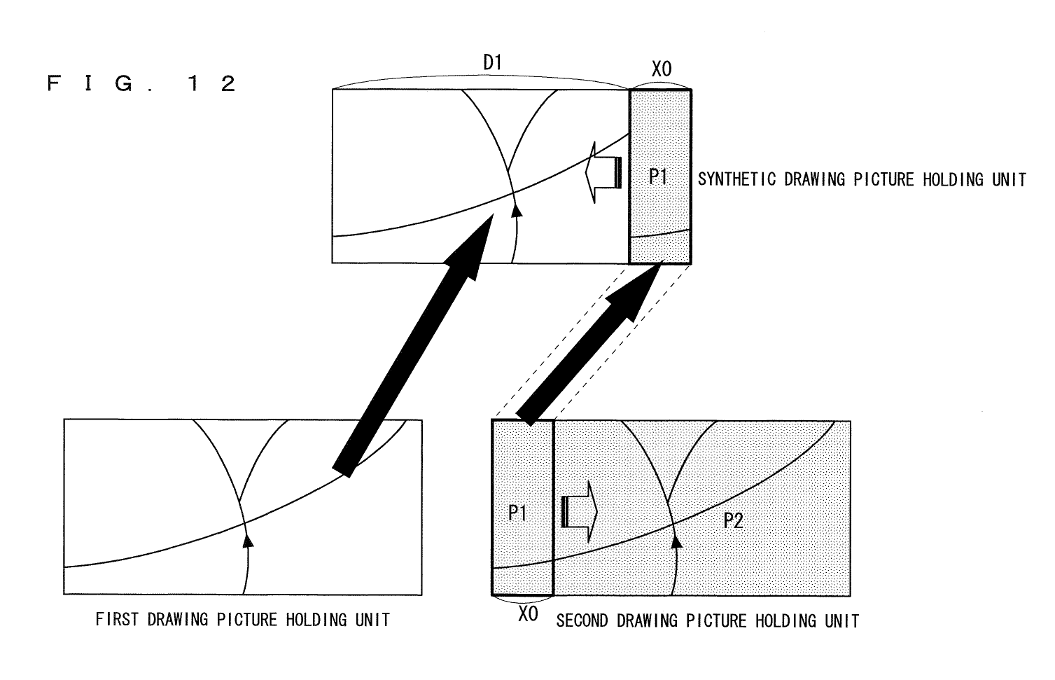

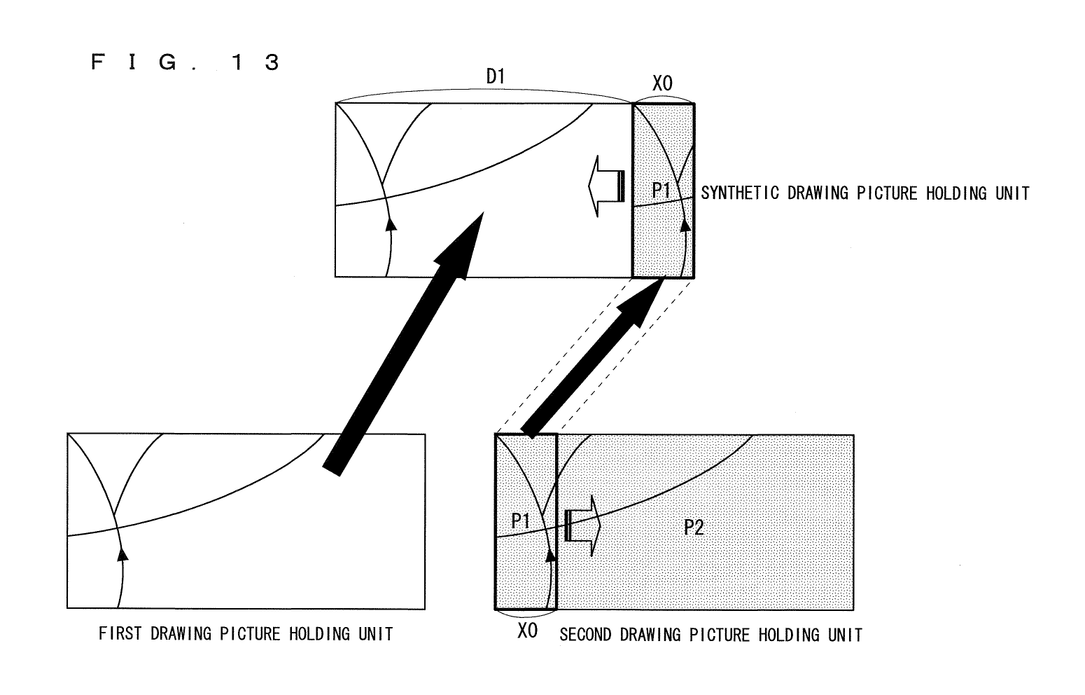

Subsequently in step ST442, an overlapping position of the second drawing picture on the first drawing picture is decided on the basis of the slide distance X0 updated in accordance with slide operation. FIGS. 12 and 13 schematically illustrate methods of synthesizing drawing pictures in cases where drawing objects are displayed at different positions in the drawing pictures.

If the slide distance X0 is zero, the overlapping position is decided so that the second drawing picture is completely out of the display screen. In this case, the second drawing picture is out of the display screen at the (right) side opposite to that shown in FIGS. 9 and 10.

If the slide distance X0 is updated to a value other than zero, the overlapping position of the second drawing picture on the first drawing picture is decided on the basis of the slide distance X0 corresponding to user's gesture operation relevant to this update.

Then in step ST443, the second drawing picture is drawn in a state of being overlapped on the first drawing picture in accordance with the overlapping position, more particularly, the overlapping start position. In a case where the second drawing picture is slid from the right into the display screen, drawing is executed in the state where the second drawing picture is overlapped so that the left end thereof coincides with the overlapping start position.

A portion not overlapped with the first drawing picture (P2 in FIGS. 12 and 13) is not displayed on the display screen. In this state, the display screen displays the first drawing object in the first drawing picture having the width D1 and not overlapped with the second drawing picture as well as the second drawing object in the second drawing picture having width equal to the slide distance X0 from the left end of the second drawing picture (P1 in FIGS. 12 and 13). These drawing objects are displayed laterally opposite to those shown in FIGS. 9 and 10.

The motions of board slide have been described above. These motions may be possibly performed in various cases of slide directions, sliding manners of the map drawing picture, and the like.

Curtain Slide

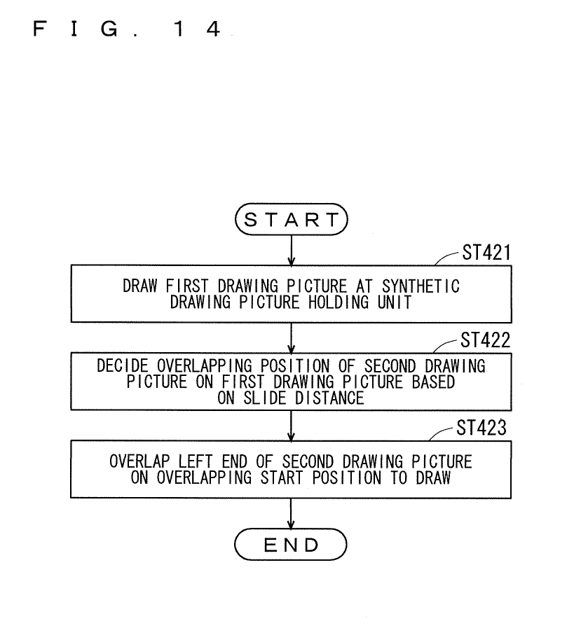

Formation of a synthetic drawing picture by means of curtain slide (step ST17 in FIG. 3) is described next with reference to FIGS. 14 to 16. Curtain slide is of a sliding type in which a display region is changed (increased or decreased) successively with a drawing object being displayed at a fixed position. Described in particular is a case where the upper second drawing picture is slid rightward out of the display screen from a completely overlapped state.

In which sliding type a synthetic drawing picture is formed can be distinguished on the basis of a mode of user's gesture operation or can be preset in accordance with combination of maps to be displayed.

Initially in step ST421, the first drawing picture held in the first drawing picture holding unit 404 is drawn at the synthetic drawing picture holding unit 408.

Subsequently in step ST422, an overlapping position of the second drawing picture on the first drawing picture is decided on the basis of the slide distance X0 updated in accordance with slide operation.

If the slide distance X0 is zero, the overlapping position is decided so that the first drawing picture and the second drawing picture are completely overlapped with each other and the second drawing object completely masks the first drawing object. If attention points are set, the overlapping position is preferably decided so that a first attention point in the first drawing picture is overlapped and coincides with a second attention point in the second drawing picture on the display screen. In other words, when the first drawing picture and the second drawing picture each include a peripheral map of the vehicle, the overlapping position is preferably decided so that the current positions of the vehicle in these drawing pictures coincide with each other.

If the slide distance X0 is updated to a value other than zero, the overlapping position of the second drawing picture on the first drawing picture is decided on the basis of the slide distance X0 corresponding to user's gesture operation.

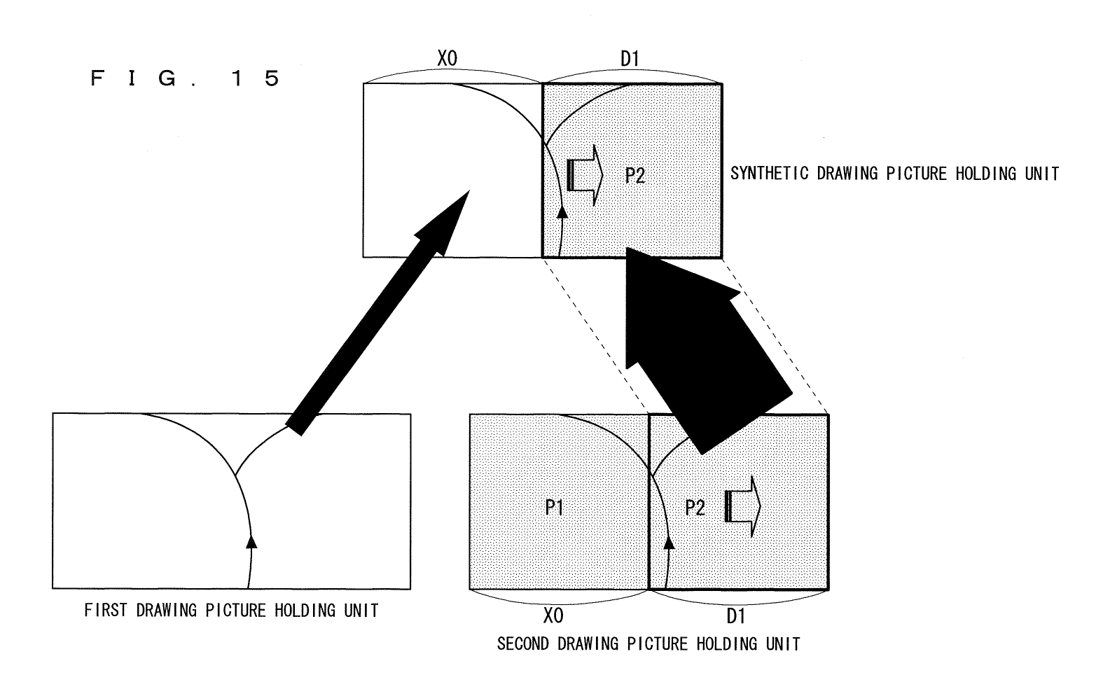

In the drag mode, an overlapping start position is set with a shift distance from a position on the display screen initially touched by a user (the slide distance X0 in FIG. 15) being considered as an offset.

The overlapping start position is set similarly in the shutter mode, in which the overlapping position is returned to an original position simultaneously when a user terminates operation of touching the display screen.

In the flick mode, the overlapping start position of the second drawing picture is set with an amount increasing with time (the slide distance X0 in FIG. 15 increasing with time) being considered as an offset.

Then in step ST423, the second drawing picture is drawn in a state of being overlapped on the first drawing picture in accordance with the overlapping position, more particularly, the overlapping start position. In a case where the second drawing picture is slid rightward out of the display screen, drawing is executed in the state where the second drawing picture is overlapped so that the gradually removed left end thereof coincides with the overlapping start position. In other words, the overlapping start position coincides with the position offset from the left end of the second drawing picture by the slide distance X0.

A portion in the second drawing picture removed from the first drawing picture (P1 in FIG. 15) is not displayed on the display screen. In this state, the display screen displays the first drawing object in the first drawing picture having width equal to the slide distance X0 and not overlapped with the second drawing picture as well as the second drawing object in the second drawing picture having the width D1 from the right end of the second drawing picture (P2 in FIG. 15).

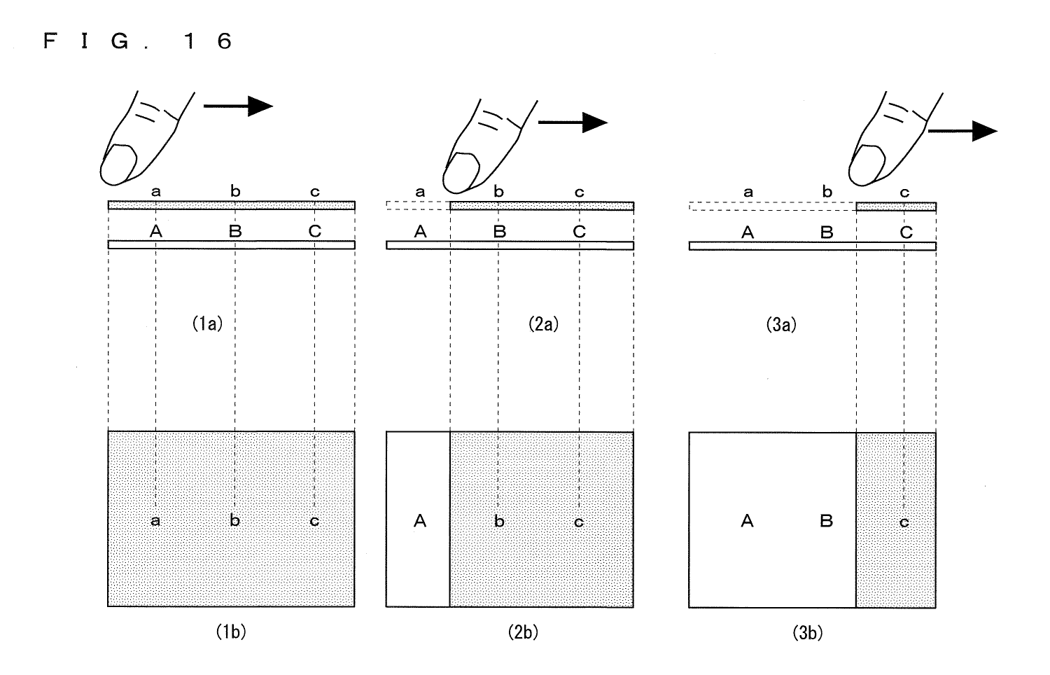

Sequentially forming a synthetic drawing picture as described above enables motions shown in FIG. 16 (sliding out by means of curtain slide). In FIG. 16, a second drawing picture including a drawing object a, a drawing object b, a drawing object c, and a second background drawing object is overlapped on a first drawing picture including a drawing object A, a drawing object B, a drawing object C, and a first background drawing object. It is assumed that the drawing object B is located at a first attention point in the first drawing picture and the drawing object b is located at a second attention point in the second drawing picture. The first background drawing object and the second background drawing object can be rectangular objects being equal in size to the drawing pictures and painted in cream. The drawing object a, the drawing object b, and the drawing object c are drawn on the second background drawing object in the second drawing picture.

In FIG. 16, portions (1a), (2a), and (3a) are pattern views of the lower first drawing picture and the upper second drawing picture seen in a lateral direction, whereas portions (1b), (2b), and (3b) are pattern views of the first drawing picture and the second drawing picture seen from above.

A user performs rightward drag operation in FIG. 16 at the input/display unit 1. In this case, the overlapping start position in the upper second drawing picture is updated sequentially (from 1a to 3a through 2a, or from 1b to 3b through 2b). The second drawing picture is displayed while being slid successively like pulling a curtain (curtain slide), with the drawing object being displayed at a fixed position.

In the state of (1a) and (1b), the first drawing picture and the second drawing picture are in a completely overlapped state and the second background drawing object masks the drawing objects A, B, and to C. If the second drawing picture is smaller than the first drawing picture, the second drawing picture has only to be overlapped on a region in the first drawing picture equal in size to the second drawing picture.

In the state of (2a) and (2b), the drawing object b and the drawing object c are displayed on the display screen of the input/display unit 1, whereas the leftmost drawing object a is not displayed. Meanwhile, the drawing object A is displayed whereas the drawing objects B and C are masked by the second background drawing object and are not displayed. Furthermore, relative positional relationship between the upper second drawing picture and the lower first drawing picture is fixed. In other words, the first attention point and the second attention point always coincide with each other on the display screen.

In the state of (3a) and (3b), the upper second drawing picture is removed further to the right, and the drawing object b is also removed from the display screen of the input/display unit 1 and is not displayed. Meanwhile, the drawing object A and the drawing object B are displayed whereas the drawing object C is masked by the second background drawing object and is not displayed. In a case where attention points are set, the drawing object B serving as a first attention point is displayed at a position of the removed drawing object b serving as a second attention point. It is thus possible to easily comprehend the relevance between these drawing objects (see also FIG. 15). Furthermore, relative positional relationship between the upper second drawing picture and the lower first drawing picture is fixed.

The second background drawing object is assumed to be in plain cream. If there is gradation in color in FIG. 16 such that the drawing object a and its vicinity is in cream and the drawing object c and its vicinity is in pink, the portions (1a), (2a), and (3a) have a drawing background color close to uniform pink.

In the curtain slide described above, the second drawing object is displayed at an unchanged position and the second drawing picture is slid, so that the lower first drawing picture is visible in a varied range. Described herein is the case where the second drawing picture is slid rightward out of the display screen by means of curtain slide. The slide direction is not limited to a uniform direction such as rightward, leftward, upward, or downward. The second drawing picture can be slid radially from the position touched by a user. There may be various cases in which the second drawing picture blinks or fades while being slid.

The sliding method described above enables slide operation regardless of the position operated with touching or the like by a user in the display area of the second drawing picture. There can be alternatively limitation to the display range of the second drawing picture for accepting slide operation. For example, in the display range of the second drawing picture, only a region around the boundary with the first drawing picture can be set to accept slide operation.

The area accepting slide operation can be displayed by means of an icon or the like. In this case, it is possible to accept all of drag operation, flick operation, and transition of ordinary operation by simple touch operation. This leads to provision of a device of fine usability.

In the above example, the second background drawing object is assumed to be equal in size to the drawing picture, be in cream, and have a rectangular shape. The background drawing object is not limited to such a rectangular shape, but can have a trapezoidal shape, have an elliptical shape, or be punched. Furthermore, the background drawing object is not limited to a light color. The background drawing object having gradation or a pattern enables display excellent in design.

In the above example, the first information storage 2 and the second information storage 3 store the first drawing object and the second drawing object, respectively. The overall controller 402 can alternatively generate both or either one of the drawing objects through software processing. For example, the overall controller 402 can generate a sign indicating the position of its own car in accordance with a program. The overall controller 402 can alternatively generate both or either one of the background drawing objects through software processing.

The above example refers to the method of rendering in the drawing picture the background drawing object as a rectangular drawing object. The method of generating a background drawing object is not limited to this method. In a case where the drawing picture itself has a function of generating a background color corresponding to a background drawing object, the overall controller 402 can set the background color of each of the first drawing picture holding unit and the second drawing picture holding unit through software processing.

In another case where the synthetic drawing unit 407 inputs setting of a background color of each of the first drawing picture and the second drawing picture to generate a synthetic drawing picture in accordance with the hardware structure or software processing, the overall controller 402 can set the background color of each of these drawing pictures through software processing.

A drawing object in the present description has a concept including an object eventually displayed at the input/display unit 1 through software processing mentioned above.

Center-Fixing Display Slide

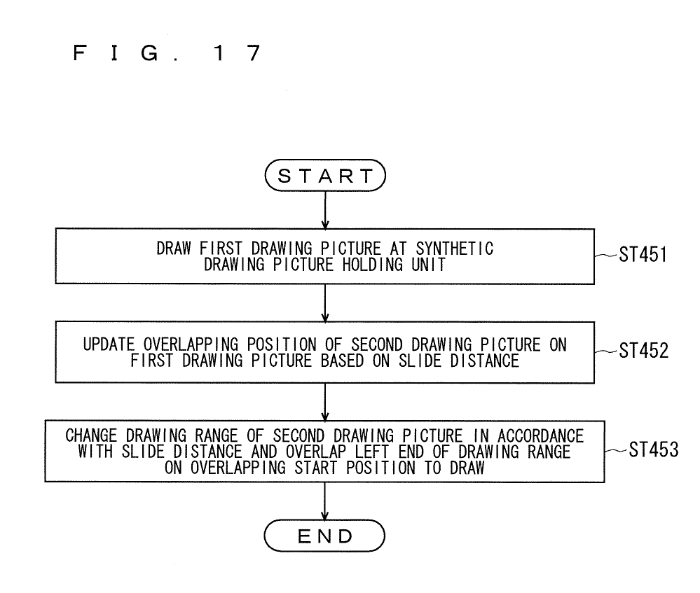

Center-fixing display slide is described next with reference to FIGS. 17 to 19. In the present description, center-fixing display slide is of a sliding type in which a drawing object displayed at the center of a display area is fixed before and after the sliding even though the sliding changes the area of the display area in the drawing picture.

FIG. 17 is a flowchart illustrating detailed behavior of forming a synthetic drawing picture (step ST17 in FIG. 3) by means of center-fixing display slide. Initially in step ST451 in FIG. 17, the synthetic drawing unit 407 draws, at the synthetic drawing picture holding unit 408, the first drawing picture held in the first drawing picture holding unit 404.

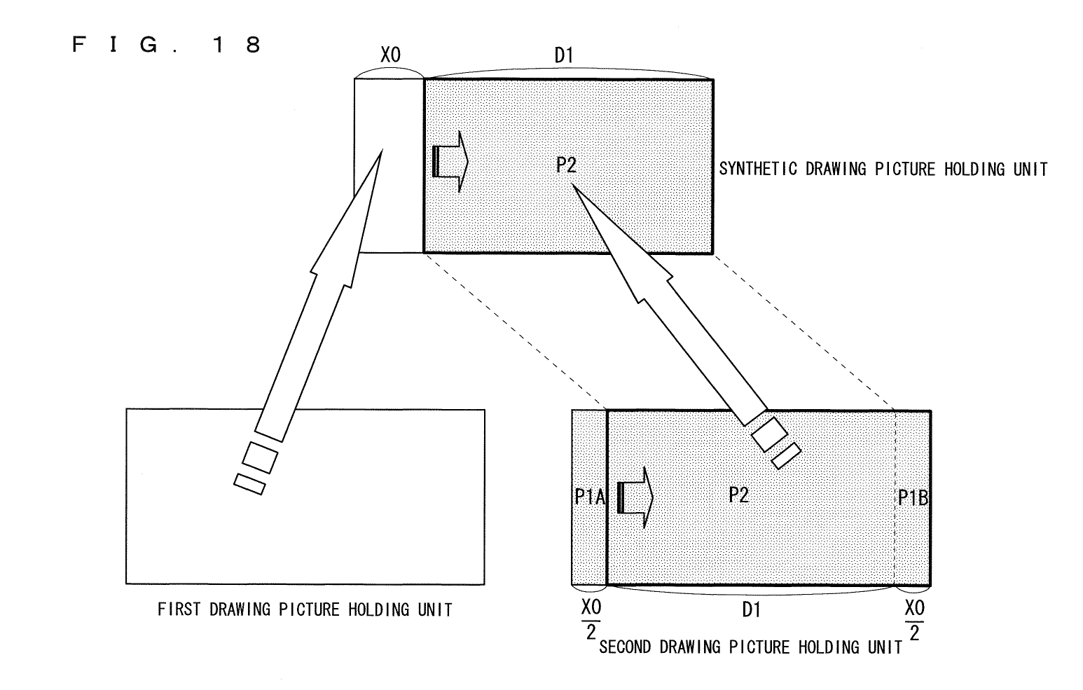

Subsequently in step ST452, an overlapping position of the second drawing picture on the first drawing picture is decided on the basis of the slide distance X0 updated in accordance with slide operation. FIG. 18 schematically illustrates a method of synthesizing drawing pictures.

If the slide distance X0 is zero, an overlapping position preset at the initial stage is adopted. In this case, it is assumed that the overlapping position is set so that the first drawing picture and the second drawing picture are in a completely overlapped state and the second drawing object completely masks the first drawing object.

If the slide distance X0 is updated to a value other than zero, the overlapping position of the second drawing picture on the first drawing picture is decided on the basis of user's gesture operation.

In the drag mode, an overlapping start position is set with a shift distance from a position on the display screen initially touched by a user (the slide distance X0 in FIG. 18) being considered as an offset.

The overlapping start position is set similarly in the shutter mode, in which the overlapping start position is returned to an original position simultaneously when a user terminates operation of touching the display screen.

In the flick mode, the overlapping start position of the second drawing picture is set with an amount increasing with time (the slide distance X0 in FIG. 18 increasing with time) being considered as an offset.

Then in step ST453, a drawing range of the second drawing picture is drawn in a state of being overlapped on the first drawing picture in accordance with the overlapping position, more particularly, the overlapping start position. FIG. 18 exemplifies the case where the second drawing picture is slid rightward out of the display screen by the slide distance X0. In this case, the drawing range corresponds to a right region with respect to a position offset from the left end of the second drawing picture by X0/2 as a half of the slide distance X0. The drawing range is drawn in a state of being overlapped on the first drawing picture so that the left end of the drawing range of the second drawing picture coincides with the overlapping start position.

In the second drawing picture, the display screen does not display a portion outside the drawing range (P1A in FIG. 18) and a portion that is included in the drawing range but is not overlapped on the first drawing picture (P1B in FIG. 18). In this state, the display screen displays the first drawing object in the first drawing picture having width equal to the slide distance X0 and not overlapped with the second drawing picture as well as the second drawing object in the second drawing picture having the width D1 (the width overlapped on the first drawing picture) and a reference point distant by X0/2 from the left end of the second drawing picture (P2 in FIG. 18).

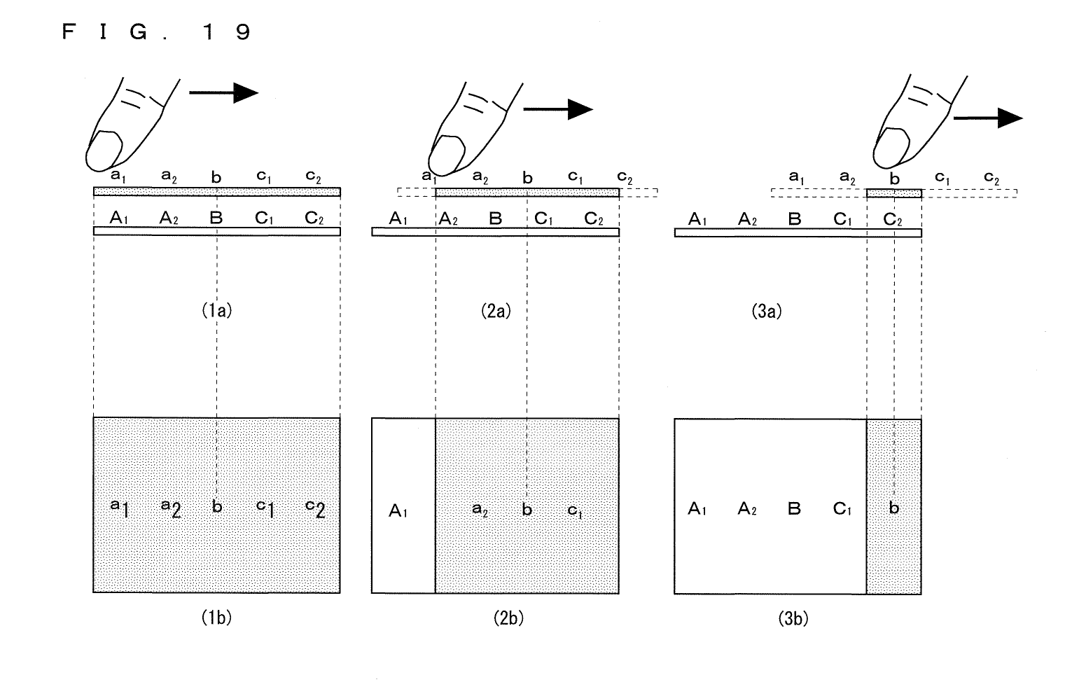

The motions shown in FIG. 19 (sliding out by means of center-fixing display slide) are achieved by repetitively forming a synthetic drawing picture as described above in the loop of steps ST14 to ST 18 in FIG. 3. In FIG. 19, a second drawing picture including drawing objects a1, a2, b, c1, and c2, and a second background drawing object is overlapped on a first drawing picture including drawing objects A1, A2, B, C1, and C2, and a first background drawing object.

The first background drawing object and the second background drawing object can be rectangular objects being equal in size to the drawing pictures and painted in cream. The drawing object a, the drawing object b, and the drawing object c are drawn on the second background drawing object in the second drawing picture.

In FIG. 19, portions (1a), (2a), and (3a) are pattern views of the first drawing picture and the second drawing picture seen in a lateral direction, whereas portions (1b), (2b), and (3b) are pattern views of the first drawing picture and the second drawing picture seen from above.

A user touches the input/display unit 1 with a finger and shifts the finger rightward in the figure without releasing (drag operation). In this case, the overlapping start position of the second drawing picture on the first drawing picture is updated sequentially (from 1a to 3a through 2a, or from 1b to 3b through 2b). The second drawing picture is displayed while being slid rightward on the display screen, with the second drawing object being displayed fixedly at the center of the display region (center-fixing display slide).

In the state of (1a) and (1b), the first drawing picture and the second drawing picture are in a completely overlapped state and the second background drawing object masks the first drawing objects A₁, A₂, B, C₁, and C₂. The second drawing object b is displayed at the center of the display region in the second drawing picture.

In the state of (2a) and (2b), the second drawing objects a₂, b, and c₁ are displayed on the display screen. In contrast, the leftmost second drawing object a₁ is out of the drawing range and the rightmost second drawing object c₂ is removed from the display screen of the input/display unit 1, both of which are not displayed. Meanwhile, the first drawing object A₁ is displayed. The second drawing object b is displayed at the center of the second drawing picture.

In the state of (3a) and (3b), the upper second drawing picture is further removed from the display screen of the input/display unit 1, and the second drawing object c1 is not displayed either. The second drawing object a₂ is also out of the drawing range so as not to be displayed. The second drawing object b is displayed at the center of the second drawing picture in this case.

As described above, by center-fixing display slide, the content displayed at the center (the second drawing object b) is fixed before and after the sliding. It is thus a sliding method suitable for a case of decreasing a display region while fixing a content displayed at the center of the original display region, for example.

### Specific Example 1

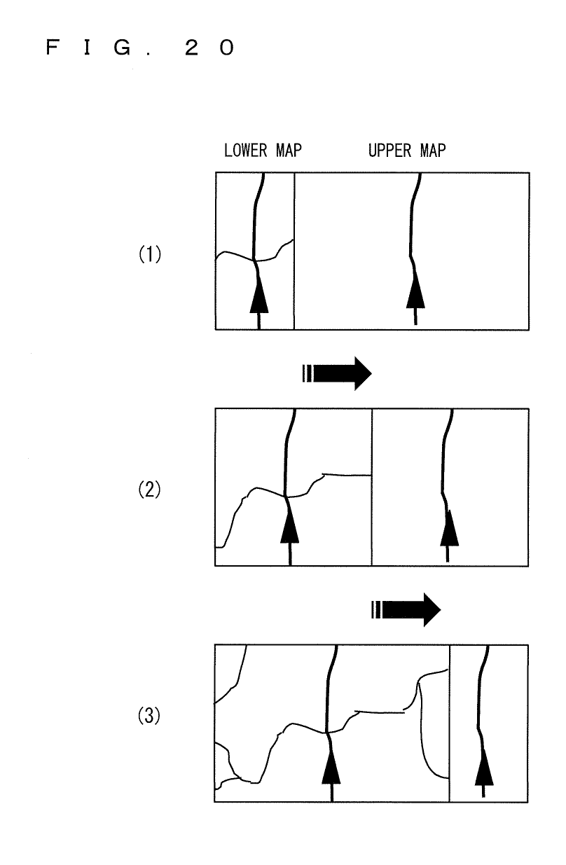

Map display behavior of changing display of one of the first and second drawing pictures in association with input of user operation to the other one of the first and second drawing pictures according to the specific example 1 is described next with reference to FIGS. 20 to 22.

FIG. 20 exemplifies display of an upper map displaying only a national road in the periphery of its own car overlapped on a lower map displaying the national road and local roads in the periphery of its own car. In other words, the first drawing picture displays the map of the national road and the local roads whereas the second drawing picture displays the map of only the national road. A route of its own car is displayed at the lateral center of the display region in each of these drawing pictures. The position of its own car is displayed in the lower half with respect to the longitudinal center of the display region, so that the displayed route includes a route to be traveled longer than a route having traveled.

FIGS. 20(1) to 20(3) show sequential states of sliding the upper map by means of center-fixing display slide. When the upper map is slid rightward, the lower map is increased in display area. The drawing object is displaced in the lower map so that the position of its own car and the route are displayed at the center of the display region even after the upper map has been slid.

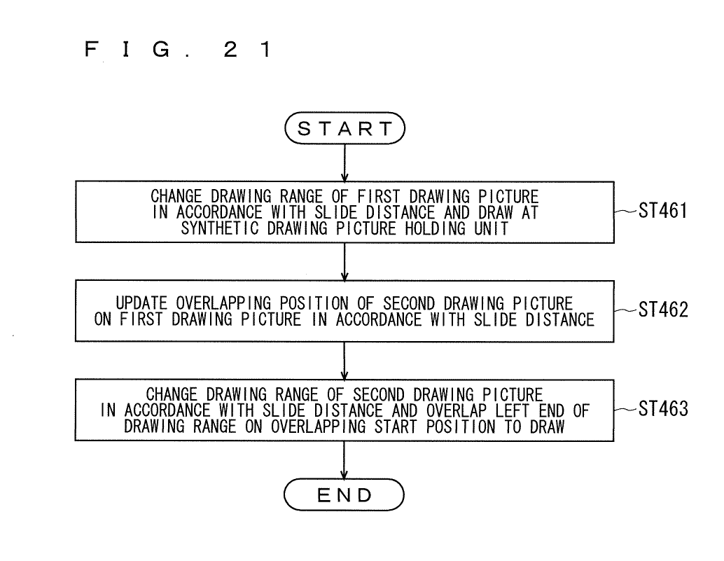

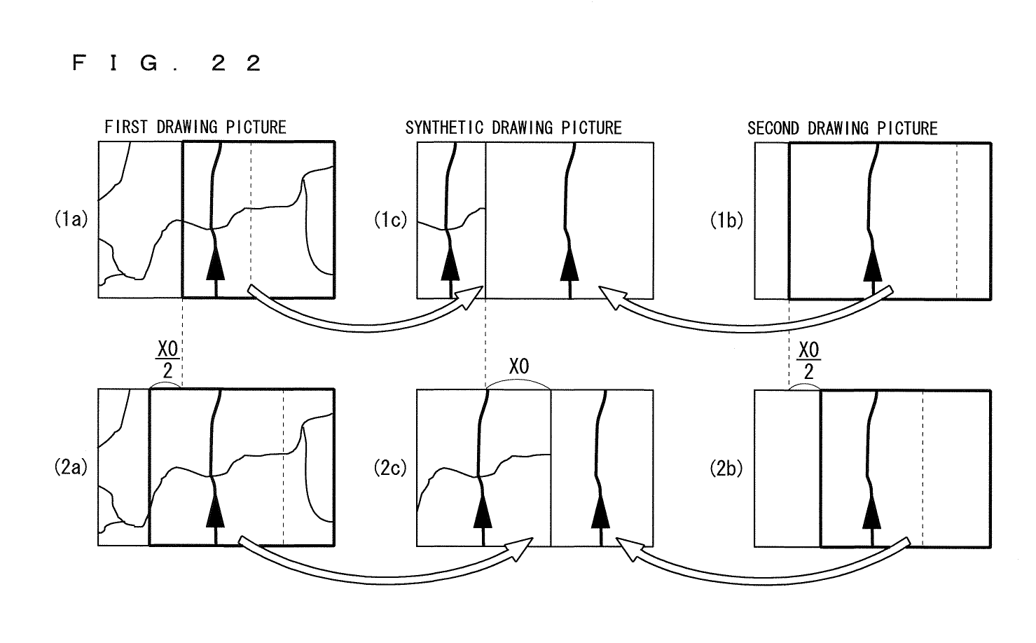

FIG. 21 is a flowchart illustrating detailed behavior of forming a synthetic drawing picture according to the specific example 1 (step ST17 in FIG. 3). FIG. 22 is a view indicating drawing ranges of these drawing pictures.

As shown in FIG. 22(1a), the first information drawing unit 403 draws at the first drawing picture holding unit 404 the first drawing picture in the entire display area around the current display range. In the first drawing picture, the drawing range indicated by a bold frame is included in the synthetic drawing picture.

As shown in FIG. 22(1b), the second information drawing unit 405 similarly draws at the second drawing picture holding unit 406 the second drawing picture in the entire display area around the current display range. In the second drawing picture, the drawing range indicated by a bold frame is included in the synthetic drawing picture.

When a user performs slide operation, in step ST461, the synthetic drawing unit 407 changes the drawing range of the first drawing picture in accordance with a slide distance, and then draws the drawing range at the synthetic drawing picture holding unit 408. In a case where a user drags the second drawing picture rightward by X0, as shown in FIG. 22(2a), the drawing range of the first drawing picture is extended leftward by X0/2.

Subsequently in step ST462, the overlapping position of the second drawing picture on the first drawing picture is updated in accordance with the slide distance. As shown in FIG. 22(2c), the overlapping start position is displaced rightward by the slide distance X0 in this case.

Subsequently in step ST463, the drawing range of the second drawing picture is changed in accordance with the slide distance and is then overlapped on the first drawing picture so as to be drawn. As shown in FIG. 22(2b), the left end of the drawing range of the second drawing picture is displaced rightward by X0/2 in this case. The drawing range of the second drawing picture is drawn in a state of being overlapped on the first drawing picture so that the left end of the drawing range of the second drawing picture coincides with the overlapping start position updated in step ST462.

As shown in FIG. 22(2c), the second drawing picture is thus slid by the distance X0. Furthermore, in each of the drawing pictures, the position of its own car and the route is displayed fixedly at the center of the display region before and after the sliding.

According to the specific example 1, when a user performs slide operation on the second drawing picture, in the first drawing picture of which display region has a variable area, the display position of the first drawing object is changed in the synthetic drawing picture so that the first drawing object is displayed fixedly at the center of the display region. In other words, when the second drawing picture is slid rightward by X0, the first drawing picture is board slid by X0/2. In a case of expanding the display area of the lower map including the national road and the local roads as shown in FIG. 20(1), the display area of the lower map can be increased by sliding the upper map rightward as shown in FIGS. 20(2) and 20(3). Furthermore, the lower map constantly displays its own car and the route at the center of the display range, and also displays local roads and the like in the periphery of its own car in accordance with the display area. A user is thus capable of smoothly changing the display region in the periphery of its own car while comprehending the position of its own car.

In the above example, the content displayed at the center of the first drawing picture is fixed by changing the drawing range of the first drawing picture. The content displayed at the center can be fixed by forming a new drawing object with the drawing range of the first drawing picture remaining the same.

### Specific Example 2

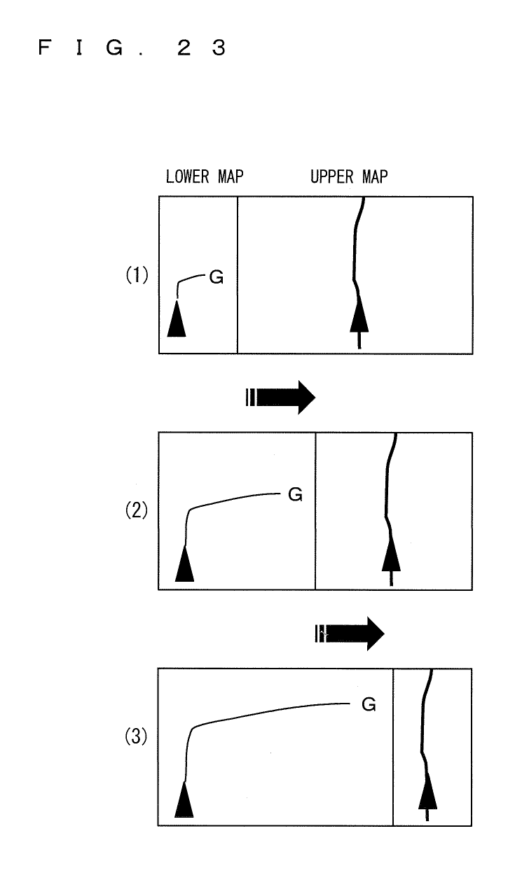

Map display behavior of changing display of one of the first and second drawing pictures in association with input of user operation to the other one of the first and second drawing pictures according to the specific example 2 is described next with reference to FIGS. 23 to 25.

FIG. 23 exemplifies display of an upper map displaying the periphery of its own car overlapped on a lower map displaying an entire route from the position of its own car to a destination. In other words, the first drawing picture displays the entire route map whereas the second drawing picture displays the peripheral map of its own car. The route of its own car is displayed at the lateral center of the display region in the peripheral map of its own car. The position of its own car is displayed in the lower half with respect to the longitudinal center of the display region, so that a route to be traveled is displayed longer than a route having traveled.

In the state shown in FIG. 23(1), the position of its own car and the route are displayed at around the center of the display region in the upper map and there are regions on the right and left ends thereof displaying nothing. Decrease in display region thus causes no trouble in display of the upper map. In this case, as shown in FIGS. 23(2) and 23(3), the upper map is slid rightward by means of center-fixing display slide within a range achieving visual recognition of the peripheral map of its own car, and the display region in the lower map is extended.

The scale of the lower map is further changed in accordance with the extension of the display region. When the display scale of the first drawing object in the first drawing picture is changed in accordance with overlap control in this manner and the entire route map is displayed fully in the display region, it is possible to display the plurality of drawing pictures by effectively utilizing the display screen having the limited area.

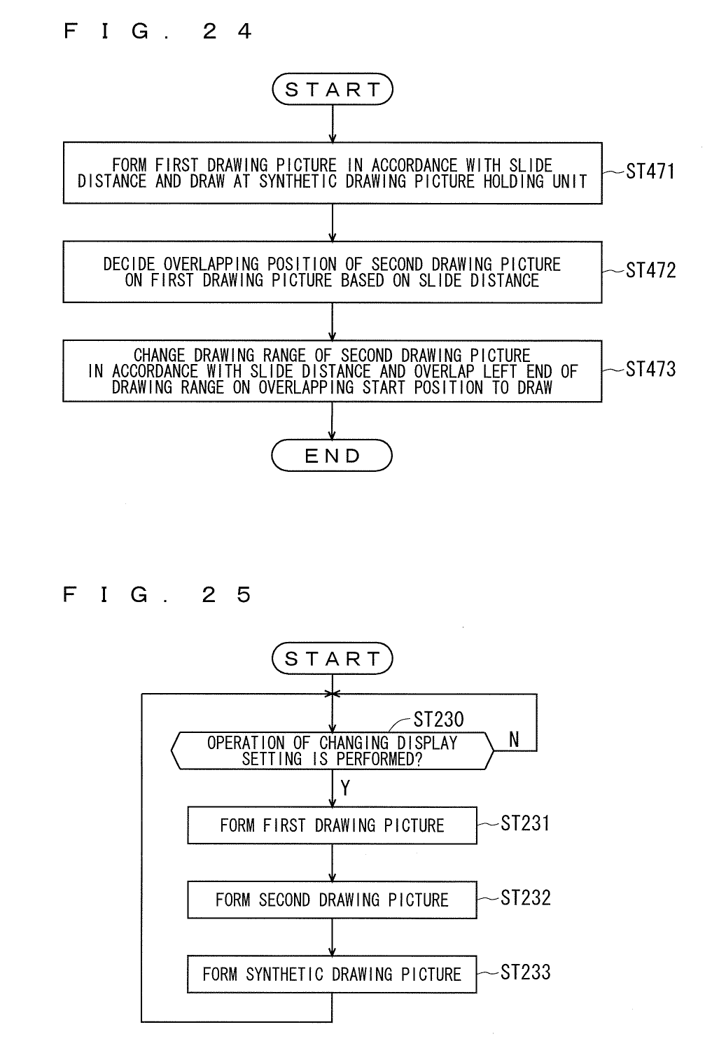

FIG. 24 is a flowchart illustrating detailed behavior of forming a synthetic drawing picture according to the specific example 2 (step ST17 in FIG. 3). The flowchart in FIG. 24 is described below by exemplifying a case where a user performs operation of sliding the second drawing picture rightward by X0.

When a user performs slide operation, in step ST471, there is formed a new first drawing picture including the first drawing object of a scale changed in accordance with a slide distance, and this first drawing picture is drawn at the synthetic drawing picture holding unit. When the second drawing picture is slid rightward by X0, the display region in the first drawing picture is increased in width by X0. The scale of the first drawing object is thus changed so as to be adapted to a new display area. In order to achieve this behavior, the first information drawing unit 403 receives a new first drawing object from the first information storage 2 and draws a new first drawing picture at the first drawing picture holding unit 404 with use of this new first drawing object. The synthetic drawing unit 407 draws the new first drawing picture at the synthetic drawing picture holding unit 408.

Steps ST 472 and 473 are not described herein because they are similar to steps ST 462 and 463 in FIG. 21 described in the specific example 1.

In such a map display method, operation of sliding the upper map once enables change in display range of the lower map as well as change to a most appropriate scale so as to adapt the entire route map displayed in the lower map into the changed display range. This method thus improves usability for a user.

### Specific Example 3

Described next is map display behavior of changing display of one of the first and second drawing pictures in association with input of user operation to the other one of the first and second drawing pictures according to the specific example 3. According to the specific example 3, when a user performs operation of changing a drawing object in one of the drawing pictures, a drawing object in the other one of the drawing pictures is changed in association therewith.

In a case where the second drawing picture displays a current map and the first drawing picture displays a past map in an identical geographical range, a user is capable of checking the past map where appropriate by sliding the second drawing picture. In such a state of use of comparing the maps displayed in the two drawing pictures, the drawing objects in these drawing pictures are changed so as to be associated with each other. This configuration improves usability for a user.

Examples of such association between drawing objects include association in scale of maps. It is assumed that the second drawing picture displays a current map and the first drawing picture displays a past map, respectively on the scale of 1 to 25000. When a user performs operation of changing the scale of the current map to 1 to 50000, the second drawing picture displays the current map on the scale of 1 to 50000 and the display scale of the past map in the first drawing picture is also changed to 1 to 50000.

Such association in scale between the first drawing picture and the second drawing picture facilitates comparison between the current map and the past map.

FIG. 25 is a flowchart illustrating behavior according to the specific example 3 of the map display device. The overall controller 402 initially determines whether or not the input/display unit 1 has received input of changing display setting from a user (step ST230). It is assumed that the input/display unit 1 has received input of operation of changing the scale of the current map in the second drawing picture from 1 to 25000 to 1 to 50000.

A first drawing picture is then formed (step ST231). More specifically, the first information drawing unit 403 receives a new first drawing object from the first information storage 2 and draws the first drawing picture at the first drawing picture holding unit 404. In this case, a new map on the scale of 1 to 50000 is formed as the first drawing picture in association with the operation of changing the second drawing picture.

A second drawing picture is then formed (step ST232). More specifically, the second information drawing unit 405 receives a new second drawing object from the second information storage 3 and draws the second drawing picture at the second drawing picture holding unit 406. In this case, a new map on the scale of 1 to 50000 is formed as the second drawing picture by reflecting the operation of changing display setting as inputted by a user in step ST230.

The synthetic drawing unit 407 then forms a synthetic drawing picture from the first drawing picture and the second drawing picture (step ST233). In the synthetic drawing picture, the drawing range of the second drawing picture and the overlapping position of the second drawing picture on the first drawing picture remain the same as the picture having been displayed before changing the display setting. The first drawing picture is initially drawn at the synthetic drawing picture holding unit 408, the second drawing picture is then overlapped on the first drawing picture so that the end of the drawing range of the second drawing picture coincides with the overlapping start position. The synthetic drawing picture is drawn at the synthetic drawing picture holding unit 408.

In this manner, the synthetic drawing picture held in the synthetic drawing picture holding unit 408 is outputted to the input/display unit 1 and is displayed on the display screen of the input/display unit 1.

### Modification Examples

The input/display unit 1 integrally includes an input unit that receives user input information and a display that displays a map drawing picture in accordance with the received input information and behavior control by the controller 4. The device can alternatively include separate configurations for achieving these functions. Furthermore, the drawing object displayed on the drawing picture is not limited to that related to map display. It is possible to display a drawing object of any type in accordance with demand of a user.

When the input/display unit 1 is embodied by the touch panel according to the present embodiment and overlap of drawing pictures is changed in accordance with gesture operation, a user is capable of easily performing operation. In a conventional map display device, picture operation has been performed by touching an operation icon displayed on a touch panel or by handling a mechanical switch or a dial. The conventional device had a user interface not necessarily achieving fine usability. The present invention adopts gesture operation that is applied to a portable terminal having a touch panel such as a smartphone. This achieves a user interface of fine usability.

The present invention is effectively utilized in picture operation on a map display device that is used under a condition of limited operation time, such as a map display device equipped on a vehicle. Furthermore, if slide directions of a drawing picture or display effects of a drawing picture being slid have flexibility, picture operation can additionally have an entertainment aspect.

The input/display unit 1 can be embodied by not only an ordinary touch panel but also a three-dimensional touch panel that is of a capacitance detection type and is capable of detecting approach and contact of a finger.

The first information storage 2 and the second information storage 3 can be provided as separate storage media as shown in FIG. 1, or can be included in one storage medium. The first information storage 2 and the second information storage 3 can alternatively communicate with an external storage medium to obtain map information or the like.

The sliding method according to the present embodiment is just an example. A map drawing picture can be updated in the slide display mode by any method other than the sliding method of the present embodiment.

The upper drawing picture and the lower drawing picture are not necessarily equal in size. The drawing pictures are not necessarily large enough to cover the entire display screen.

The specific example 2 exemplifies change in scale of the lower map in accordance with a display area. The scale of the lower map can be changed successively or stepwise in association with sliding of the upper map. When the upper map and the lower map have equal display areas, these maps can be displayed on equal scales. Alternatively, the scale of the upper map can be changed in association with sliding of the upper map whereas the scale of the lower map can be fixed.

In the specific example 2, both the first and second drawing pictures include road maps. One of the drawing pictures may not display a map. For example, the first drawing picture can include an alphabetical search icon picture or a route guide picture. The size of such a picture can be set freely in accordance with a slide area, so that search can be easily performed or the displayed map can be easily recognized and usability is improved.

The specific example 3 exemplifies the scale of a map as display setting associated between the drawing pictures. Such association between the drawing pictures can be achieved in other display setting such as the scale in height of a three-dimensional map, a sight angle in the BIRD VIEW (registered trademark), or a color tone.

Furthermore, the specific example 3 exemplifies change of display of the first drawing picture in association with change of display setting to the second drawing picture. Alternatively, display of the second drawing picture can be changed in association with change of display setting to the first drawing picture.

Effects

A map display device according to the present embodiment is capable of displaying a plurality of drawing pictures including a first drawing picture and a second drawing picture in an at least partially overlapping manner. The first drawing picture includes at least one first drawing object, and the second drawing picture includes at least one second drawing object. At least one of the first and second drawing objects includes a drawing object related to map information. The first drawing picture and the second drawing picture are equal or different in size. The map display device includes an input unit that receives input of user operation related to display of a drawing picture, and a controller 4 for controlling an overlapping state between the first and second drawing pictures in accordance with input of user operation received by the input unit and outputting, to a display unit, a picture in which one of the first and second drawing objects masks the other one in a portion where the first and second drawing pictures are overlapped with each other. The controller 4 changes display of one of the first and second drawing pictures in association with input, received by the input unit, of user operation to the other one of the first and second drawing pictures. This configuration enables map display of fine usability for a user.

In the map display device according to the present embodiment, the controller 4 slides one of the first and second drawing pictures relatively to the other one so as to successively change the overlapping state between the first and second drawing pictures. A user can easily comprehend relevance between the maps.

The overlapping state between the first and second drawing pictures is controlled by center-fixing display slide by which a drawing object displayed at the center of a display region is fixed before and after the sliding. Center-fixing display slide does not change a content displayed at the center before and after the sliding. It is thus possible to appropriately adjust a display area by the slide while keeping a desired content.

The input unit and the display unit are integrally formed as the input/display unit 1 of a display device provided with a touch panel. This configuration improves convenience for user input operation.

In the portion where the first and second drawing pictures are overlapped with each other, the second drawing object masks the first drawing object. The controller 4 forms a first drawing object in accordance with input, received by the input unit, of user operation of sliding the second drawing picture, and changes the first drawing object so that a content displayed at the center of a region where the first and second drawing pictures are not overlapped with each other is not changed before and after overlap control. Alternatively, the controller 4 changes the display region in the first drawing picture so that the content displayed at the center of the region where the first and second drawing pictures are not overlapped with each other is not changed before and after the overlap control. When there is a user attention point at the center of the first drawing picture, the user attention point stays at the center even when the second drawing picture is slid and the display area of the first drawing picture is changed. This achieves map display of fine usability.

The controller 4 changes a display scale of the first drawing object in accordance with input, received by the input unit, of user operation of sliding the second drawing picture. It is assumed that a user wants to enlarge the first drawing object in the first drawing picture. When the second drawing picture is slid to extend the display region in the first drawing picture, the first drawing object is enlarged in correspondence with the size of the display region. This configuration achieves map display of fine usability for a user.

The first and second drawing objects each include a drawing object related to map information. The controller 4 changes map scales of the first and second drawing pictures so as to be associated with each other, in accordance with input of user operation received by the input unit. The user can easily compare pieces of map information in these drawing pictures.

Alternatively, the first and second drawing objects each include a drawing object related to relief map display. The controller 4 changes scales in height of the first and second drawing pictures so as to be associated with each other, in accordance with input of user operation received by the input unit. The user can easily compare pieces of map information in these drawing pictures.

Still alternatively, the first and second drawing objects each include a drawing object related to bird's-eye view information. The controller 4 changes sight angles of the first and second drawing pictures so as to be associated with each other, in accordance with input of user operation received by the input unit. The user can easily compare pieces of map information in these drawing pictures.

According to a map display device method in the present embodiment, a plurality of drawing pictures including a first drawing picture and a second drawing picture are displayed so as to be in an at least partially overlapping manner. The first drawing picture displays at least one first drawing object, and the second drawing picture displays at least one second drawing object. At least one of the first and second drawing objects includes a drawing object related to map information. The first drawing picture and the second drawing picture are equal or different in size. The map display device method includes the steps of (a) receiving input of user operation related to display of a drawing picture, (b) displaying the plurality of drawing pictures, (c) prior to the step (b), controlling an overlapping state between the first and second drawing pictures in accordance with input of user operation received in the step (a), and masking one of the first and second drawing objects with the other one in a portion where the first and second drawing pictures are overlapped with each other, and (d) prior to the step (b), changing display of one of the first and second drawing pictures in association with input, received in the step (a), of user operation to the other one of the first and second drawing pictures. This configuration enables map display of fine usability for a user.

The present invention has been described in detail. The above description merely exemplifies all aspects and the present invention is not to be limited thereto. Countless modification examples not mentioned herein are to be expected without being excluded from the scope of the present invention.

### DESCRIPTION OF REFERENCE SIGNS

1: input/display unit 2: first information storage 3: second information storage 4: controller 401: input analyzer 402: overall controller 403: first information drawing unit 404: first drawing picture holding unit 405: second information drawing unit 406: second drawing picture holding unit 407: synthetic drawing unit 408: synthetic drawing picture holding unit

1. A map display device that displays a plurality of drawing pictures including a first drawing picture and a second drawing picture in an at least partially overlapping manner,
said first drawing picture displaying at least one first drawing object,
said second drawing picture displaying at least one second drawing object,
at least one of said first and second drawing objects including a drawing object related to map information, and
said first and second drawing pictures being equal or different in size,
the map display device comprising:
an input unit that receives input of user operation related to display of a drawing picture; and
a controller for controlling an overlapping state between said first and second drawing pictures in accordance with input of user operation received by said input unit and outputting, to a display unit, a picture in which one of said first and second drawing objects masks the other one in a portion where said first and second drawing pictures are overlapped with each other; wherein
said controller changes display of one of said first and second drawing pictures in association with input, received by said input unit, of user operation to the other one of said first and second drawing pictures.

2. The map display device according to claim 1, wherein
said controller slides one of said first and second drawing pictures relatively to the other one so as to successively change the overlapping state between said first and second drawing pictures.

3. The map display device according to claim 2, wherein
said sliding includes center-fixing display slide by which said drawing object displayed at a center of a display region is fixed before and after the sliding.

4. The map display device according to claim 1, wherein
said input unit and said display unit are integrally formed as a display device provided with a touch panel.

5. The map display device according to claim 2, wherein
said second drawing object masks said first drawing object in the portion where said first and second drawing pictures are overlapped with each other, and
in accordance with input, received by said input unit, of user operation of sliding said second drawing picture, said controller changes said first drawing object so that a content displayed at a center of a region where said first and second drawing pictures are not overlapped with each other is not changed before and after said overlap control.

6. The map display device according to claim 2, wherein
said second drawing object masks said first drawing object in the portion where said first and second drawing pictures are overlapped with each other, and
said controller changes a display region in said first drawing picture so that a content displayed at a center of a region where said first and second drawing pictures are not overlapped with each other is not changed before and after said overlap control.

7. The map display device according to claim 2, wherein
said second drawing object masks said first drawing object in the portion where said first and second drawing pictures are overlapped with each other, and
in accordance with input, received by said input unit, of user operation of sliding said second drawing picture, said controller changes a display scale of said first drawing object.

8. The map display device according to claim 2, wherein
said first and second drawing objects each include a drawing object related to map information, and
said controller changes map scales of said first and second drawing pictures so as to be associated with each other, in accordance with input of user operation received by said input unit.

9. The map display device according to claim 2, wherein
said first and second drawing objects each include a drawing object related to relief map display, and
said controller changes scales in height of said first and second drawing pictures so as to be associated with each other, in accordance with input of user operation received by said input unit.

10. The map display device according to claim 2, wherein
said first and second drawing objects each include a drawing object related to display of a bird's-eye view, and
said controller changes sight angles of said first and second drawing pictures so as to be associated with each other, in accordance with input of user operation received by said input unit.

11. A map display method of displaying a plurality of drawing pictures including a first drawing picture and a second drawing picture in an at least partially overlapping manner,
said first drawing picture displaying at least one first drawing object,
said second drawing picture displaying at least one second drawing object,
at least one of said first and second drawing pictures including a drawing object related to map information, and
said first and second drawing pictures being equal or different in size,
the map display method including the steps of:
(a) receiving input of user operation related to display of a drawing picture,
(b) displaying said plurality of drawing pictures,
(c) prior to said step (b), controlling an overlapping state between said first and second drawing pictures in accordance with input of user operation received in said step (a), and masking one of said first and second drawing objects with the other one in a portion where said first and second drawing pictures are overlapped with each other, and
(d) prior to said step (b), changing display of one of said first and second drawing pictures in association with input, received in said step (a), of user operation to the other one of said first and second drawing pictures.

12. The map display method according to claim 11, wherein
in said step (c), one of said first and second drawing pictures is slid relatively to the other one so as to successively change the overlapping state between said first and second drawing pictures.

13. The map display method according to claim 12, wherein
said sliding includes center-fixing display slide by which said drawing object displayed at a center of a display region is fixed before and after the sliding.
